(19) United States
(12) Patent Application Publication
(10) Pub. No.: US 2025/0294387 A1
(43) Pub. Date: Sep. 18, 2025

(54) Time Aligned Radio-Layer and Application-Layer Measurements for Dual Connectivity

(71) Applicant: Telefonaktiebolaget LM Ericsson (publ), Stockholm (SE)

(72) Inventors: Ali Parichehrehteroujeni, Linköping (SE); Johan Rune, Lidingö (SE); Luca Lunardi, Genoa (IT); Filip Barac, Huddinge (SE); Angelo Centonza, Granada (ES); Cecilia Eklöf, Täby (SE)

(21) Appl. No.: 18/860,359

(22) PCT Filed: Jun. 29, 2023
(86) PCT No.: PCT/SE2023/050678

§ 371 Date: Oct. 25, 2024

Related U.S. Application Data
(60) Provisional application No. 63/357,186, filed on Jun. 30, 2022.

(51) Int. Cl. H04W 24/08; H04L 41/5067

(52) U.S. Cl. CPC H04W 24/08; H04L 41/5067

(57) ABSTRACT

Embodiments include methods performed by a first radio access network (RAN) node configured to provide dual connectivity for a user equipment (UE) together with a second RAN node. Such methods include receiving, from another node or function associated with the RAN, a measurement configuration that includes a first configuration for quality-of-experience (QoE) measurements and an indication that the QoE measurements should be time aligned with minimization of drive testing (MDT) measurements. Such methods include sending the first configuration to the UE, receiving from the UE a first indication that an event associated with the QoE measurements has occurred, and responsive to the first indication, initiating first MDT measurements and sending to the second RAN node a command to initiate MDT measurements that are time aligned with the QoE measurements associated with the first configuration. Other embodiments include complementary methods for the second RAN node and a measurement collection node or function (MCNF).

### TECHNICAL FIELD

The present disclosure relates generally to wireless communication networks, and more specifically to techniques for coordinating radio-layer (e.g., for minimization of drive testing, MDT) and application-layer (e.g., for quality-of-experience, QoE) measurements for a user equipment (UE) that is configured with dual connectivity to a radio access network (RAN).

### BACKGROUND

Currently the fifth generation (5G) of cellular systems is being standardized within the Third-Generation Partnership Project (3GPP). 5G is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other 20) network functions (NFs), such as Session Management Function(s) (SMF).

Although not shown, in some deployments the 5GC can be replaced by an Evolved Packet Core (EPC, 198), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in the EPC via respective S1-C interfaces and to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

The NG-RAN is layered into a Radio Network Layer (RNL) and a Transport Network Layer (TNL). The NG-RAN logical nodes and interfaces between them, is defined as part of the RNL. For each NG-RAN interface (NG, Xn, F1) the related TNL protocol and the functionality are specified. The TNL provides services for user plane transport and signaling transport.

NG RAN logical nodes (e.g., gNB 100) include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

Centralized control plane protocols (e.g., PDCP-C and RRC) can be hosted in a different CU than centralized user plane protocols (e.g., PDCP-U). For example, a gNB-CU can be divided logically into a CU-CP function (including RRC and PDCP for signaling radio bearers) and CU-UP function (including PDCP for UP). A single CU-CP can be associated with multiple CU-UPs in a gNB. The CU-CP and CU-UP communicate with each other using the E1-AP protocol over the E1 interface. Furthermore, the F1 interface between CU and DU (see FIG. 1) is functionally split into F1-C between DU and CU-CP and F1-U between DU and CU-UP. Three deployment scenarios for the split gNB architecture shown in FIG. 1 are CU-CP and CU-UP centralized, CU-CP distributed/CU-UP centralized, and CU-CP centralized/CU-UP distributed.

Long-Term Evolution (LTE) Rel-10 introduced support for channel bandwidths larger than 20 MHz, which continues into NR. To remain compatible with legacy UEs from earlier releases (e.g., Rel-8), a wideband LTE Rel-10 carrier appears as multiple component carriers (CCs), each having the same structure as an LTE Rel-8 carrier. A Rel-10 UE can receive the multiple CCs based on Carrier Aggregation (CA). The CCs can also be considered “cells”, such that a UE in CA has one primary cell (PCell) and one or more secondary cells (SCells).

LTE Rel-12 introduced dual connectivity (DC) whereby a UE is connected to two network nodes simultaneously, thereby improving connection robustness and/or capacity. More specifically, a UE is configured with a Master Cell Group (MCG) provided by a master node (MN) and a Secondary Cell Group (SCG) provided by a secondary node (SN). Each CG is a group of serving cells that includes one MAC entity, a set of logical channels with associated RLC entities, a PCell, and optionally one or more secondary SCells. NR-DC is like LTE-DC except that MN and SN are gNBs rather than LTE eNBs. NR also supports various multi-RAT DC (MR-DC) scenarios in which one of the MN and SN provides E-UTRA/LTE access and the other provides NR access.

Quality of Experience (QoE) measurements were specified for UEs operating in earlier-generation LTE and UMTS networks and are being specified in 3GPP for UEs operating in NR networks. Measurements in all of these networks operate according to similar high-level principles, with the purpose of measuring the end-user experience for certain applications over the network. For example, LTE and NR networks support QoE measurements for streaming services and for MTSI (Mobility Telephony Service for IMS).

Radio resource control (RRC) signaling can be used to configure application-layer QoE measurements in UEs and to collect QoE measurement result files from configured UEs. In particular, an application-layer measurement configuration from a core network (e.g., EPC, 5GC) or a network operations/administration/maintenance (OAM) function is encapsulated in a transparent container and sent to a UE's serving base station (e.g., eNB, gNB), which forwards it to the UE access stratum (AS) in an RRC message. Application-layer measurements made by the UE are encapsulated in a transparent container that the UE AS sends to the serving base station in an RRC message. The serving base station then forwards the container to a Trace Collector Entity (TCE) or a Measurement Collection Entity (MCE) associated with the CN.

In addition to conventional or legacy QoE metrics, 3GPP has agreed to support so-called “RAN-visible” (or RV, for short) QoE metrics and QoE values. RVQoE metrics are a subset of legacy QoE metrics collected from UE and RVQoE values are derived from legacy QoE metrics through a model and/or function. Both of these are RAN-visible because they can be useful (in some way) to the RAN (e.g., NG-RAN).

In addition, UEs and RAN nodes can be configured to perform and report measurements to support minimization of drive testing (MDT), which is intended to reduce and/or minimize the requirements for manual testing of network performance (i.e., by driving around the geographic coverage of the network). The MDT feature was first studied in LTE Rel-9 (e.g., 3GPP TR 36.805 v9.0.0) and first standardized in Rel-10. MDT can address various network performance improvements such as coverage optimization, capacity optimization, mobility optimization, quality-of-service (QOS) verification, and parameterization for common channels (e.g., PDSCH). In general, MDT measurements can be management-based or signaling-based, and are supported for DC scenarios and for the split node architecture shown in FIG. 1.

### SUMMARY

In general, QoE measurements relate to application-layer performance while MDT measurements relate to radio-layer performance. Conventionally, each type of measurement is collected and/or reported independently and/or without coordination with the other type. For example, QoE measurements may be logged at different times than MDT measurements.

However, there are some scenarios in which it is desirable to align, coordinate, and/or link QoE and MDT measurements. For example, necessary analysis of the QoE measurement may not be feasible without combining and matching application-layer measurements with corresponding radio-layer measurements provided by the RAN, such as MDT measurements. However, there are problems, issues, and/or difficulties aligning QoE and MDT measurements pertaining to a UE in DC with an MN and an SN.

For example, execution of signaling-based MDT measurements by the SN is not time aligned. They start upon the SN receiving the MDT configuration from the MN, and there is no mechanism for the MN to control the start of the SN's MDT measurements. As such, there is no mechanism to control time alignment between QoE measurements and SN signaling-based MDT measurements.

Likewise, management-based MDT measurements are not coordinated between a UE's MN and SN. Currently, when the MN receives a management-based MDT measurement it does not forward it to the SN, and vice versa. The MN and SN will perform and report their MDT measurements independently, and the collection entity is unable to correlate them. As such, there is no mechanism to control time alignment between QoE measurements and measurement-based MDT measurements made by two different nodes but pertaining to the same UE.

An object of embodiments of the present disclosure is to improve coordination of QoE and MDT measurements in a RAN, such as by providing, enabling, and/or facilitating solutions to exemplary problems summarized above and described in more detail below.

Embodiments include methods (e.g., procedures) for a first RAN node configured to provide DC for a UE together with a second RAN node.

These exemplary methods include receiving from another node or function associated with the RAN a measurement configuration that includes a first configuration for QoE measurements and an indication that the QoE measurements and the MDT measurements should be time aligned. These exemplary methods also include sending the first configuration to a UE and receiving from the UE a first indication that an event associated with the QoE measurements has occurred. These exemplary methods also include, in response to the first indication, initiating first MDT measurements and sending to the second RAN node a command to initiate MDT measurements that are time aligned with the QoE measurements associated with the first configuration.

In some embodiments, the first configuration is for RAN-visible QoE measurements. In some embodiments, the other node or function associated with the RAN is one of the following: an OAM node coupled to the RAN; or a node or function of a core network (CN) coupled to the RAN. In some embodiments, the first indication is one of the following: a session start indication for a UE application session having characteristics related to the first configuration; or a session start indication for a UE QoE measurement session associated with the first configuration.

In some embodiments, the measurement configuration also includes a second configuration for MDT measurements and the indication also indicates that the QoE measurements should be time aligned with the MDT measurements associated with the second configuration. In some of these embodiments, these exemplary methods also include storing the second configuration upon receipt, such that the first MDT measurements are initiated according to the stored second configuration.

In some embodiments, at least a portion of the second configuration is be sent to the UE node together with the first configuration. In some embodiments, one or more of the following information is sent to the second RAN node together with the command:
at least a portion of the second configuration;
one or more identifiers of the first MDT measurements;
a start time for the first MDT measurements;
one or more UE identifiers;
the first indication received from the UE, or a representation thereof; and an indication or request for the second RAN node to provide information about second MDT measurements performed by second RAN node.

Other embodiments include methods (e.g., procedures) for a second RAN node configured to provide DC for a UE together with a first RAN node. In general, these methods are complementary to the methods for a first RAN node summarized above.

These exemplary methods include receiving, from the first RAN node, a command to initiate MDT measurements that should be time aligned with QoE measurements performed by the UE. These exemplary methods also include initiating time aligned MDT measurements in accordance with the command. These exemplary method also include sending, to a measurement collection node or function (MCNF) associated with the RAN, an MDT report comprising results of the time aligned MDT measurements.

In some embodiments, the QoE measurements include RAN-visible QoE measurements. In some embodiments, the command is based on initiation of one of the following at the UE: an application session having characteristics related to the QoE measurements; or a QoE measurement session. In some embodiments, the command is received together with a second configuration for MDT measurements by the second RAN node and the time aligned MDT measurements are initiated according to the second configuration. In some embodiments, one or more of the following information is received from the first RAN node together with the command:
at least a portion of a second configuration for second MDT measurements by the second RAN node;
one or more identifiers of first MDT measurements by the first RAN node;
a start time for the first MDT measurements;
one or more UE identifiers;
a first indication that a UE event associated with the QoE measurements has occurred; and
an indication or request for the second RAN node to provide information about second MDT measurements performed by second RAN node;

Other embodiments include methods (e.g., procedures) for an MCNF associated with a RAN. In general, these methods are complementary to the methods for a first RAN node and a second RAN node, summarized above.

These exemplary methods can include receiving the following information from a first RAN node:
a QoE report comprising results of QoE measurements performed by a UE according to a first configuration;
one or first more identifiers of first MDT measurements performed by the first RAN node according to a second configuration; and
one or more second identifiers of second MDT measurements performed by a second RAN node according to the second configuration.
   The QoE measurements, the first MDT measurements, and the second MDT measurements are time aligned, as summarized above. In some embodiments, the QoE measurements include RAN-visible QoE measurements. These exemplary methods can also include collecting the first MDT measurements and the second MDT measurements from the RAN and correlating the QoE measurements, the first MDT measurements, and the second MDT measurements based on the one or more first identifiers and the one or more second identifiers.

Other embodiments include RAN nodes (e.g., gNBs or units thereof such as CU-CPs) and MCNFs (e.g., OAM, TCE, MCE, etc.) configured to perform operations corresponding to any of the exemplary methods described herein. Other embodiments include non-transitory, computer-readable media storing program instructions that, when executed by processing circuitry, configure such RAN nodes or MCNFs to perform operations corresponding to any of the exemplary methods described herein.

By enabling RAN nodes arranged in DC with a single UE to perform MDT measurements that are time aligned with QoE measurements (including legacy and RVQoE measurements), these and other embodiments described herein can facilitate easy correlation of these measurements by a collection entity. This can lead to detection, interpretation, and/or understanding of possible application-related issues and/or possible radio- and network-related issues. Availability of time aligned measurements in this manner can lead to improved network performance. Embodiments also provide these advantages when used in RAN nodes arranged in the split node architecture discussed herein.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIGS. 4A-B illustrate various aspects of QoE measurement configuration for a UE in an LTE network.

FIGS. 5A-C illustrate various aspects of QoE measurement collection for a UE in an LTE network.

FIG. 6 is a signal flow diagram that illustrates QoE measurement collection and reporting in an LTE network.

FIGS. 7-8 show signal flow diagrams of exemplary management-based MDT activations in a gNB-DU and a gNB-CU-CP, respectively.

FIGS. 9-11 show signaling diagrams of various techniques to control start/execution of MDT measurements in DC scenarios when the alignment of MDT and QoE measurements is requested by OAM, according to various embodiments of the present disclosure.

FIG. 12A-B shows a signaling diagram of another technique to control start/execution of MDT measurements in DC scenarios when the alignment of MDT and QoE measurements is requested by OAM, according to other embodiments of the present disclosure.

FIG. 13 shows a flow diagram of an exemplary method (e.g., procedure) for a first RAN node (e.g., base station, eNB, gNB, ng-eNB, etc. or component/unit/function thereof), according to various embodiments of the present disclosure.

FIG. 14 shows a flow diagram of an exemplary method (e.g., procedure) for a second RAN node (e.g., base station, eNB, gNB, ng-eNB, etc. or component/unit/function thereof), according to various embodiments of the present disclosure.

FIG. 15 shows a flow diagram of an exemplary method (e.g., procedure) for a measurement collection node or function (MCNF, e.g., MCE, TCE, OAM, etc.), according to various embodiments of the present disclosure.

FIG. 16 shows a communication system according to various embodiments of the present disclosure.

FIG. 17 shows a UE according to various embodiments of the present disclosure.

FIG. 18 shows a network node according to various embodiments of the present disclosure.

FIG. 19 shows host computing system according to various embodiments of the present disclosure.

FIG. 20 is a block diagram of a virtualization environment in which functions implemented by some embodiments of the present disclosure may be virtualized.

FIG. 21 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, operation, etc. are to be interpreted openly as referring to at least one instance of the element, apparatus, component, means, operation, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with 25 the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or similar terminology is sometimes used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

FIG. 2 shows another high-level view of an exemplary 5G network architecture, including an NG-RAN (299) and a 5GC (298). As shown in the figure, the NG-RAN can include gNBs (e.g., 210a,b) and ng-eNBs (e.g., 220a,b) that are interconnected with each other via respective Xn interfaces. The gNBs and ng-eNBs are also connected via the NG interfaces to the 5GC, more specifically to Access and Mobility Management Functions (AMFs, e.g., 230a,b) via respective NG-C interfaces and to User Plane Functions (UPFs, e.g., 240a,b) via respective NG-U interfaces. Moreover, the AMFs can communicate with Policy Control Functions (PCFs, e.g., 250a,b) and Network Exposure Functions (NEFs, e.g., 260a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one or more cells (e.g., 211a-b, 221a-b). Depending on the cell in which it is located, a UE (205) can communicate with the gNB or ng-eNB serving that cell via the NR or LTE radio interface, respectively. Although FIG. 2 shows gNBs and ng-eNBs separately, it is also possible that a single NG-RAN node provides both types of functionality.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), 5 channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

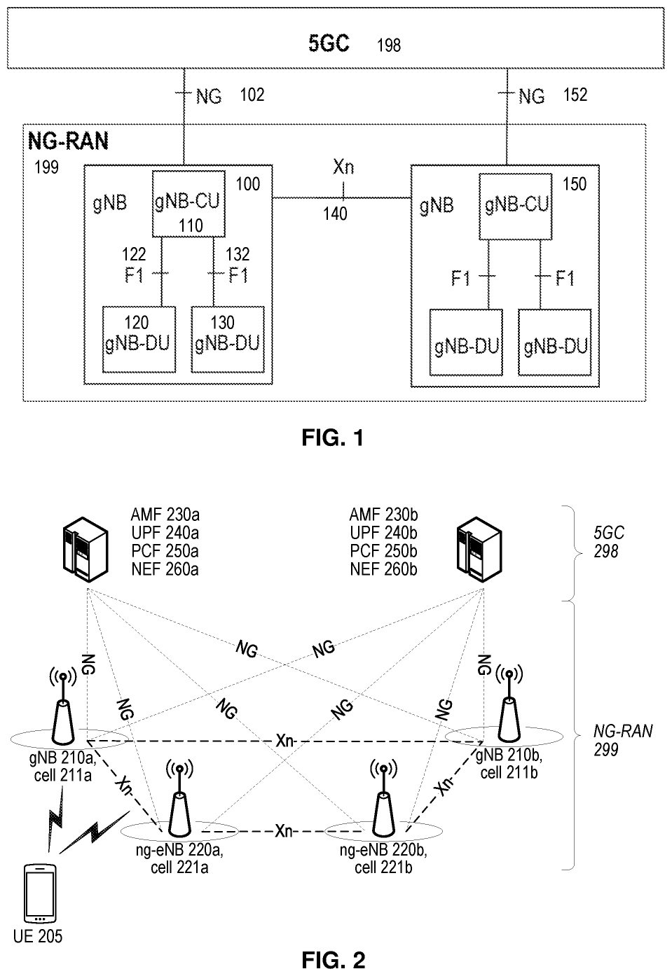

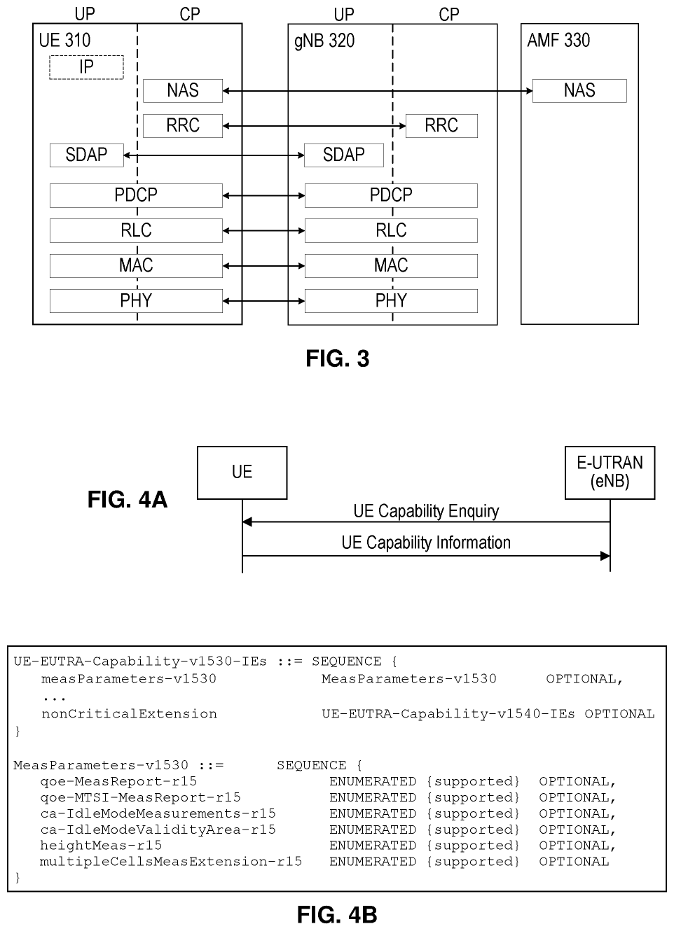

FIG. 3 shows an exemplary configuration of NR user plane (UP) and control plane (CP) protocol stacks between a UE (310), a gNB (320), and an AMF (330), such as those shown in FIGS. 1-2. Physical (PHY), Medium Access Control (MAC), Radio Link Control (RLC), and Packet Data Convergence Protocol (PDCP) layers between the UE and the gNB are common to UP and CP. PDCP provides ciphering/deciphering, integrity protection, sequence numbering, reordering, and duplicate detection for both CP and UP. In addition, PDCP provides header 15 compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC IDLE state until an RRC connection is established with the network, at which time the UE will transition to RRC CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

As briefly mentioned above, QoE measurements were specified for UEs operating in earlier-generation LTE and UMTS networks and are being specified in 3GPP for UEs operating in NR networks. QoE measurements in all of these networks operate according to similar high-level principles, with the purpose of measuring the end-user experience for certain applications over the network. For example, QoE measurements for streaming services and for MTSI (Mobility Telephony Service for IMS) are supported in LTE and NR networks.

QoE measurements may be initiated towards the RAN from an OAM node generically for a group of UEs (e.g., all UEs meeting one or more criteria), or they may also be initiated from the CN to the RAN for a specific UE. The former is often referred to as “management-based QoE” (or “m-based QoE” for short) and is used when the OAM system is interested in general QoE statistics from a certain area (which is configured as an area scope). The management based QoE configuration is sent directly from the OAM system to the RAN nodes controlling cells that are within the area scope. Each RAN node then selects UEs that are within the area scope (and that also fulfill any other relevant condition, such as supporting a particular application/service type) and sends the QoE configuration to these UEs.

Signaling-based QoE (s-based QoE) is used by the OAM system to collect QoE measurement results from a specific UE, e.g., because the user of the UE has filed a complaint. The OAM system sends the s-based QoE configuration to the HSS (in EPS/LTE) or UDM (in 5GS/NR), which forwards the QoE configuration to the UE's CN, e.g., to MME in EPS/LTE or AMF in 5G/NR. The CN then forwards the s-based QoE configuration to the RAN node that serves the specific UE, and the RAN node sends it to the UE.

The UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality, but it will still partly reuse the Trace signaling mechanisms.

In NR and LTE, a globally unique QoE reference (formed of MCC+MNC+QMC ID, where the QMC ID is a string of 24 bits) will be associated with each QoE configuration. The QoE reference is included in the container with measurement instructions and also sent to the serving RAN node (e.g., gNB). For the communication between the RAN node and the UE, the QoE reference is replaced by a shorter identifier denoted as measConfigAppLayerId, which is locally unique within a UE (i.e., one-to-one mapping between a measConfigAppLayerId and a QoE reference for each QoE configuration provided to a UE). The measConfigAppLayerId is stored in the UE AS and also forwarded to the UE application layer in an AT Command together with the service type indication and the container with the measurement instructions.

Reports with collected QoE measurement results (QoE reports) are sent from the UE application layer to the UE AS, which forwards them to the serving RAN node, which in turn forwards them to the MCE. These QoE measurement results are placed in a “container”, which is uninterpretable by the UE AS and the RAN. QoE reporting can be configured to be periodic or only at the end of an application session. Furthermore, the RAN can instruct the UE to pause QoE reporting, e.g., in case the cell/gNB is in a state of overload.

Neither the RAN nor the UE AS is implicitly aware of when an application session with an associated QoE measurement is ongoing. To alleviate this lack of awareness, session start/stop indications can be sent from the UE application layer to the UE AS and from the UE AS to the RAN. A session stop indication may be implicit in the form of a QoE report sent when the application session and the associated QoE measurement session have ended.

The RAN may decide to release a QoE configuration in a UE at any time, as an implementation-based decision. Typically, it is done when the UE has moved outside an area configured for the QoE measurements, commonly referred to as the area scope. One benefit of legacy or conventional QoE solutions is the ability to keep the QoE measurement for an entire session, even during a handover. In some cases, the UE can continue QoE measurements on an ongoing application session until the application session ends, even if the UE in the meantime moves out of the configured area scope.

In legacy LTE s-based QoE, a “TRACE START” S1AP message is used by the Evolved Packet Core (EPC) to initiate QoE measurements by a specific UE. This message carries details about the measurement configuration the application should collect in the Container for application-layer measurement configuration IE, which transparent to the RAN. This message also includes details needed to reach the TCE to which the measurements should be sent.

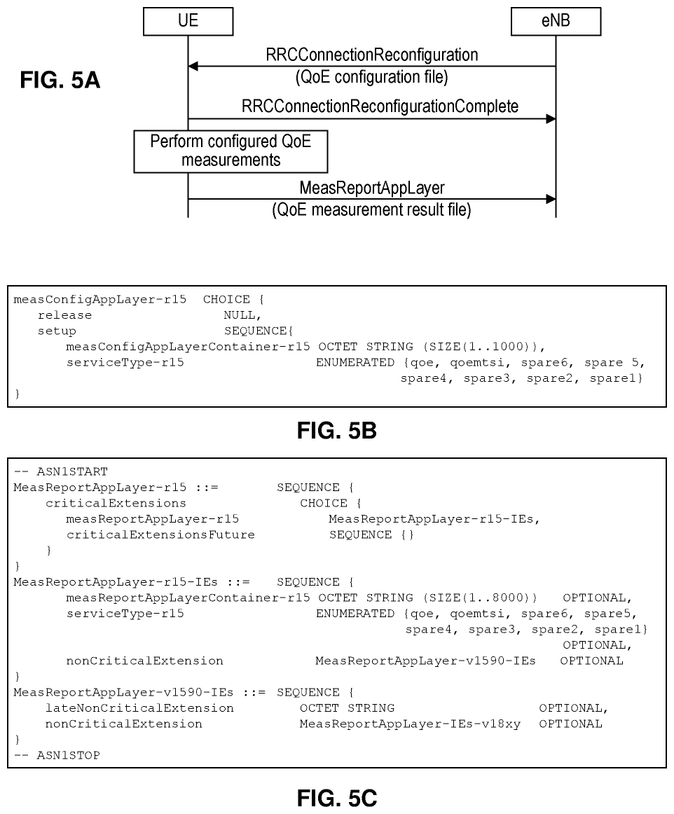

FIGS. 4A-B illustrate a procedure between an E-UTRAN and a UE for configuring QoE measurements in an LTE network. FIG. 4A shows an exemplary UE capability transfer procedure used to transfer UE radio access capability information from the UE to E-UTRAN. Initially, the E-UTRAN can send a UECapabilityEnquiry message. The UE can respond with a UECapabilityInformation message that includes a UE-EUTRA-Capability IE.

This IE may further include a UE-EUTRA-Capability-v1530 IE, which can be used to indicate whether the UE supports QoE Measurement Collection for streaming services and/or MTSI services. In particular, the UE-EUTRA-Capability-v1530 IE can include a measParameters-v1530 IE containing the information about the UE's measurement support. FIG. 4B shows exemplary ASN.1 data structures for UE-EUTRA-Capability-v1530 and measParameters-v1530 IEs, with relevant fields defined in Table 1 below.

TABLE 1

| Field name | Description |
|---|---|
| qoe-MeasReport | Indicates whether the UE supports QoE Measurement |
| | Collection for streaming services. |
| qoe-MTSI- | Indicates whether the UE supports QoE Measurement |
| MeasReport | Collection for MTSI services. |

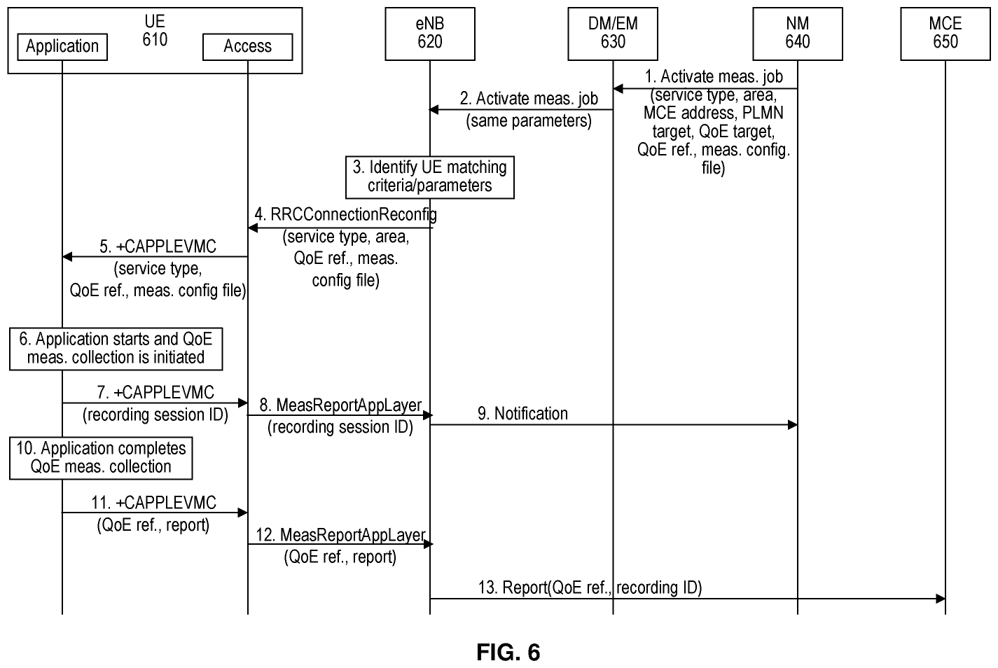

FIGS. 5A-C illustrate various aspects of QoE measurement configuration collection for a UE in an LTE network. In particular, FIG. 5A shows an exemplary signal flow diagram of a QoE measurement collection process for LTE. To initiate QoE measurements, the serving eNB sends to a UE in RRC_CONNECTED state an RRCConnectionReconfiguration message that includes a QoE configuration file, e.g., a measConfigAppLayer IE within an OtherConfig IE. As discussed above, the QoE configuration file is an application layer measurement configuration received by the eNB (e.g., from EPC) encapsulated in a transparent container, which is forwarded to UE in the RRC message. The UE responds with an RRCConnectionReconfigurationComplete message.

More specifically, a UE can perform various operations when it receives an RRCConnectionReconfiguration message including an OtherConfig IE that includes a measConfigAppLayer IE. In particular, if measConfigAppLayer is set to setup, the UE forwards measConfigAppLayerContainer (e.g., FIG. 5B) to upper layers considering the service Type and considers itself to be configured to send application layer measurement reports. Otherwise (i.e., if measConfigAppLayer is set to release), the UE informs upper layers to clear the stored application layer measurement configuration, discards application layer measurement report information received from upper layers, and considers itself not to be configured to send application layer measurement reports.

When configured to do so, the UE performs the configured measurements and sends a MeasReportAppLayer RRC message to the eNB, including a QoE measurement result file. Although not shown, the eNB can forward this result file transparently (e.g., to EPC). More specifically, if the UE has been configured with SRB4, the UE can:
set the measReportAppLayerContainer in the MeasReportAppLayer message to the value of the application layer measurement report information;
set the serviceType in the MeasReportAppLayer message to the type of the application layer measurement report information; and
submit the MeasReportAppLayer message to lower layers for transmission via SRB4.

FIG. 5B shows an exemplary ASN.1 data structure for a measConfigAppLayer IE. The setup includes the transparent container measConfigAppLayerContainer which specifies the QoE measurement configuration for the Application of interest. In the service Type field, a value of “qoe” indicates Quality of Experience Measurement Collection for streaming services and a value of “qoemtsi” indicates Enhanced Quality of Experience Measurement Collection for MTSI. This field also includes various spare values.

FIG. 5C shows an exemplary ASN.1 data structure for a measReportAppLayer IE, by which a UE can send to the E-UTRAN (e.g., via SRB4) the QoE measurement results of an application (or service). The service for which the report is being sent is indicated in the service Type IE.

The UE Application layer measurement configuration IE described in 3GPP TS 36.413 (v.16.7.0) section 9.2.1.128 carries configuration information provided by a QoE Measurement Collection (QMC) function. This IE is signaled to the RAN (eNB) from the mobility management entity (MME) in the EPC via the S1 interface CP (e.g., S1AP protocol) as further specified in 3GPP TS 36.413. In particular, this IE is included in the Trace Activation IE, which also includes the Trace Collection Entity (TCE) IP Address IE. Table 2 below defines the container for the application layer measurement configuration.

TABLE 2

| IE/Group Name | Pres. | Range | IE type/ref. | Semantics description |
|---|---|---|---|---|
| Container for | M | | Octet string | Indicates application |
| application layer | | | (1 . . . 1000) | layer measurement |
| measurement | | | | configuration, see |
| configuration | | | | Annex L in [43]. |
| CHOICE Area Scope | M | | | |
| of QMC | | | | |
| >Cell based | | | | |
| >>Cell ID List for | | 1 . . . | | |
| QMC | | <maxnoofCellIDforQMC> | | |
| >>>E-CGI | M | | 9.2.1.38 | |
| >TA based | | | | |
| >>TA List for | | 1 . . . | | |
| QMC | | <maxnoofTAforQMC> | | |
| >>>TAC | M | | 9.2.3.7 | The TAI is derived |
| | | | | using the current |
| | | | | serving PLMN. |
| >TAI based | | | | |
| >>TAI List for | | 1 . . . | | |
| QMC | | <maxnoofTAforQMC> | | |
| >>>TAI | M | | 9.2.3.16 | |
| >PLMN area based | | | | |
| >>PLMN List for | | 1 . . . | | |
| QMC | | <maxnoofPLMNforQMC> | | |
| >>>PLMN | M | | 9.2.3.8 | |
| Identity | | | | |
| Service Type | M | | ENUMERATED | This IE indicates the |
| | | | (QMC for | service type of UE |
| | | | streaming service, | application layer |
| | | | QMC for MTSI | measurements. |
| | | | service, . . . ) | |

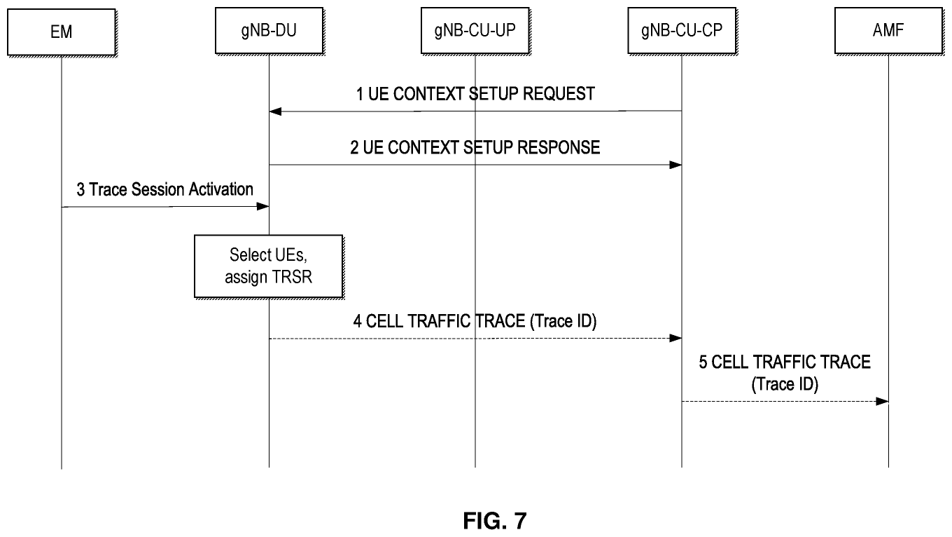

FIG. 6 shows a more detailed signal flow of activation of QoE measurement collection and reporting of collected information without UE mobility in an LTE network. This signal flow is between a measurement collection entity (MCE, 650), a network manager (NM, 640), a domain manager (DM/EM, 630), one or more eNBs (620) in E-UTRAN, and the UE (610)-particularly access stratum (or access, for short) and application parts of the UE. The following description omits these reference numbers for brevity. Although the operations shown in FIG. 6 are given numerical labels, these labels are intended to facilitate the following description rather than to require and/or imply a particular order of the operations.

In operation 1, the NM sends an Activate Measurement Job message to the DM, which forwards the message to the eNB in operation 2. The message includes a service type (e.g., streaming), an area scope, a measurement configuration file for the QoE measurements to be performed, and a QoE reference identifier. In operation 3, the eNB identifies served cells matching the area scope, as well as UEs in these served cells that match other parameters in the message (e.g., service type). The eNB can base this determination on UE capability information sent from the UE to the eNB (not shown).

In operation 4, after identifying the UE matching the received criteria, the eNB sends an RRCConnectionReconfiguration message to the AS (e.g., RRC layer) of the UE. The eNB includes the service type, the area scope (e.g., one or more cells, tracking areas, etc.), the measurement configuration file, and the QoE reference.

In operation 5, the UE AS forwards this information to the UE application part using an AT command +CAPPLEVMC, as specified in 3GPP TS 27.007 (v16.4.0). In general, AT commands can be used to transfer information between different layers in the UE, such as between application and AS. In particular, AT command +CAPPLEVMC is of the following form when used for QoE measurement configuration:
+CAPPLEVMC: <app-meas_service_type>,<start-stop_reporting>[,<app-meas_config_file_length>,<app-meas_config-file>],
   where the various fields are defined below:
<n>: integer type. Disable and enable presentation of the unsolicited result code +CAPPLEVMC to the TE.
   0 Disable presentation of the unsolicited result code,
   1 Enable presentation of the unsolicited result code.
<app-meas_service_type>: integer type. Contains the indication of what application that is target for the application-level measurement configuration.
   1 QoE measurement collection for streaming services,
   2 QoE measurement collection for MTSI services.
<start-stop_reporting>: integer type. Indicates the start and stop of the application-level measurement reporting for the application indicated by the <app-meas_service_type>.
   0 start the application-level measurement reporting,
   1 stop the application-level measurement reporting.
<app-meas_config_file_length>: integer type. Indicates the number of octets of the <app-meas_config-file> parameter.
<app-meas_config-file>: string of octets. Contains the application-level measurement configuration file for the application indicated by the <app-meas_service_type>. The parameter shall not be subject to conventional character conversion as per +CSCS.

Returning to the discussion of FIG. 6, in operation 6, the UE starts an application associated with the service type and initiates measurement collection according to the received configuration and area. The UE assigns this measurement collection a recording session ID and reports this ID (in operation 7) to the UE AS using the same AT command. In operation 8, the UE AS sends this ID to the eNB in a MeasReportAppLayer RRC message, and the eNB notifies the NM of the initiation of the measurement collection in operation 9.

The UE application layer completes the QoE measurement collection according to the received configuration (operation 10) and reports the results to the UE AS via AT command +CAPPLEVMR (operation 11) along with the associated QoE reference ID received earlier. The report can be a transparent container, as discussed earlier. AT command +CAPPLEVMC is of the following form when used for QoE measurement reporting:

+CAPPLEVMC=<app-meas_service_type>,<app-meas_report_length>,<app-meas_report> where the various fields are defined below:
<app_meas_service_type>: integer type. Contains the indication of what application that is providing the application-level measurement report.
   1 QoE measurement collection for streaming services
   2 QoE measurement collection for MTSI services
<app-meas_report_length>: integer type. Indicates the number of octets of the <app-meas_report> parameter.
<app-meas_report>: string of octets. Contains the application-level measurement configuration file for the application indicated by the <app-meas_service_type>. The parameter shall not be subject to conventional character conversion as per +CSCS.

In operation 12, the UE AS sends the report and the QoE reference ID to the eNB in a MeasReportAppLayer RRC message. The eNB subsequently forwards the report to the MCE (operation 13). In some cases, the MCE may forward the QoE measurement report to another entity in the network for analysis and further action (e.g., in the OAM system).

U.S. App. 63/092,984 by the present Applicants discloses “lightweight” QoE measurements and various techniques for transmitting, receiving, and using the same. Lightweight QoE measurements can be obtained by converting one or more QoE measurements logged in a conventional (or legacy) format into one or more lightweight QoE metrics. For example, each lightweight QoE metric can represent of one of the following:
a conventional QoE metric;
a plurality of different conventional QoE metrics for one application;
a plurality of different lightweight QoE metrics for one application;
respective values of a conventional QoE metric for a plurality of applications, and
respective values of a lightweight QoE metric for a plurality of applications.
   Each representation used by a lightweight QoE metric can be a concatenation, an index, a score, a rating based on enumerated values, a binary relation to a threshold, etc. Each conventional QoE metric represented by a lightweight QoE metric can relate to one or more of the following characteristics:
throughput per TCP socket or per access bearer, (e.g., average, max/min, standard deviation, etc.);
end to end latency (e.g., average, max/min, standard deviation, etc.);
round trip time (e.g., average, max/min, standard deviation, instant value, etc.);
uplink delay (e.g., average, max/min, standard deviation, instant value, etc.);
downlink delay (e.g., average, max/min, standard deviation, instant value, etc.);
jitter of arriving packets (e.g., average, max/min, standard deviation, instant value, etc.);
number of consecutive failures in receiving the packets (e.g., average, max/min, standard deviation, instant value, etc.);
initial playout delay;
timeliness of the packets (e.g., average, max/min, standard deviation, instant value, etc.);
application level buffer (e.g., average, max/min, standard deviation, instant value, etc.).

There are various ways to derive lightweight QoE metrics, and lightweight QoE metrics can be derived from a single conventional QoE metric or from multiple (e.g., all) conventional QoE metrics for an application. An example of the former is a lightweight representation of the average throughput (AvgThroughput) conventional QoE metric and a lightweight representation of the initial playout delay (InitialPlayoutDelay) conventional QoE metric for Progressive Download and DASH. An example of the latter is a lightweight QoE metric that represents both of these conventional QoE metrics. As another example, different subsets of conventional QoE metrics for an application can be represented by respective lightweight QoE metrics. Each subset can include one or more conventional QoE metrics.

In addition to conventional or legacy QoE metrics, 3GPP has agreed to support so-called “RAN-visible” (or RV, for short) QoE metrics and QoE values. Conventional QoE reports are intended for the MCE outside the RAN (e.g., in OAM system) and the RAN nodes are generally unable to read conventional QoE reports (although not specifically prevented from doing so). In contrast, RVQoE metrics or values are intended for the RAN and are delivered in a format that RAN nodes understand. The RVQoE metrics or values are derived from the regular QoE metrics, collected and compiled in reports by the UE application layer, and delivered to the RAN, which may use the reports for various types of optimizations. As an example, when the RAN receives RVQoE reports during an ongoing application session, the RAN can perform adaptive actions to impact the QoE of the application session while it is ongoing, such as changing various parameters related to the scheduling of the UE and the data flows related to the application session. RVQoE metrics and values are substantially similar to (e.g., a form of) lightweight QoE metrics previously disclosed by Applicant in U.S. App. 63/092,984.

In addition to QoE measurements, a UE can be configured by the network to perform logged MDT and/or immediate MDT measurements. A UE in RRC_IDLE state can be configured (e.g., via a LoggedMeasurementConfiguration RRC message from the network) to perform periodical MDT measurement logging. An MDT configuration can include logginginterval and loggingduration. The UE starts a timer (T330) set to loggingduration (e.g., 10-120 min) upon receiving the configuration, and perform periodical MDT logging every logginginterval (1.28-61.44 s) within the loggingduration while the UE is in RRC_IDLE state. In particular, the UE collects DL reference signal received strength and quality (i.e., RSRP, RSRQ) based on existing measurements required for cell reselection purposes. The UE reports the collected/logged information to the network when the UE returns to RRC_CONNECTED state.

In contrast, a UE can be configured to perform and report immediate MDT measurements while in RRC CONNECTED state. Like logged MDT, immediate MDT measurements are based on existing UE and/or network measurements performed while a UE is in RRC_CONNECTED, and can include any of the following measurement quantities:
M1: RSRP and RSRQ measurement by UE.
M2: Power Headroom measurement by UE.
M3: Received Interference Power measurement by eNB.
M4: Data Volume measurement separately for DL and UL, per QoS class indicator (QCI) per UE, by eNB.
M5: Scheduled IP layer Throughput for MDT measurement separately for DL and UL, per RAB per UE and per UE for the DL, per UE for the UL, by eNB.
M6: Packet Delay measurement, separately for DL and UL, per QCI per UE, see UL PDCP Delay, by the UE, and Packet Delay in the DL per QCI, by the eNB.
M7: Packet Loss rate measurement, separately for DL and UL per QCI per UE, by the eNB.
M8: received signal strength (RSSI) measurement by UE.
M9: round trip time (RTT) measurement by UE.

For example, the reporting of M1 measurements can be event-triggered according to existing RRM configuration for any of events A1-A6 or B1-B2. In addition, M1 reporting can be periodic, A2 event-triggered, or A2 event-triggered periodic according to an MDT-specific measurement configuration. As another example, the reporting of M2 measurements can be based on reception of Power Headroom Report (PHR), while reporting for M3-M9 can be triggered by the expiration of a measurement collection period.

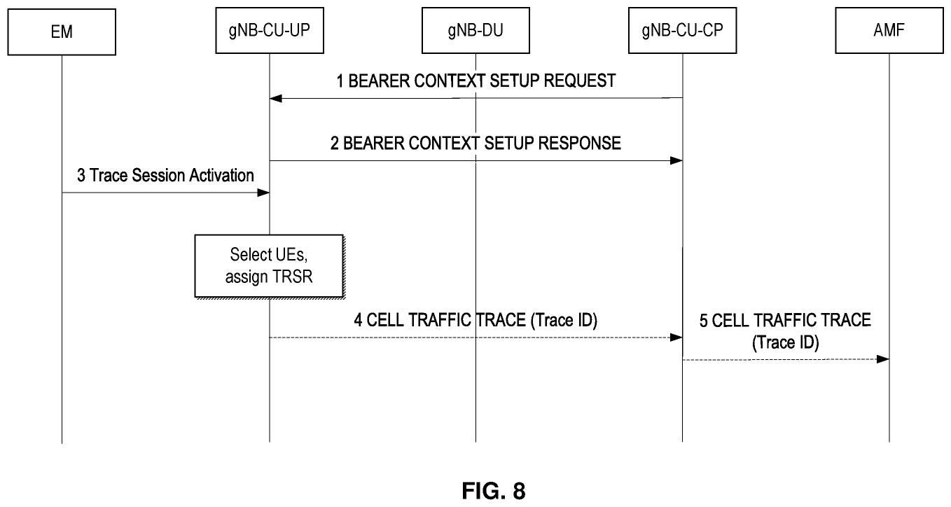

MDT measurements can also be performed in RAN nodes, including gNBs have the split node architecture shown in FIG. 1. In particular, either management- or signaling-based trace activation can be used in the split node architecture. FIGS. 7-8 show signal flow diagrams of exemplary management based MDT activations in a gNB-DU and a gNB-CU-CP, respectively.

Alternately, in the F1 signaling-based approach, the gNB-CU can send the gNB-DU a TRACE START message (via F1AP) that requests the gNB-DU to initiate a trace session for a specific UE. Upon reception of the TRACE START message, the gNB-DU initiate the requested trace session for the requested UE, as further described in 3GPP TS 32.422 (v16.8.0). In particular, the gNB-DU shall initiate the requested trace session and MDT session when the Trace Activation IE in the message includes an MDT Activation IE set to “Immediate MDT and Trace”. On the other hand, the gNB-DU shall initiate the requested MDT session ignore the Interfaces To Trace IE and Trace Depth IE (if included), when the Trace Activation IE includes the MDT Activation IE set to “Immediate MDT Only”.

Alternately, in the E1 signaling-based approach, the gNB-CU-CP can send the gNB-CU-UP a TRACE START message (via E1AP) that requests the gNB-CU-UP to initiate a trace session for a specific UE. Upon reception of the TRACE START message, the gNB-CU-UP initiates the requested trace session for the requested UE, as further described in 3GPP TS 32.422 (v16.8.0). In particular, the gNB-CU-UP shall initiate the requested MDT session ignore the Interfaces To Trace IE and Trace Depth IE (if included), when the MDT Activation IE is set to “Immediate MDT Only”.

MDT measurements are also supported for DC scenarios. However, there are problems, issues, and/or difficulties aligning QoE and MDT measurements pertaining to a UE in DC with an MN and an SN.

When an MN receives a signaling-based MDT measurement configuration from the CN (e.g., 5GC), it should forward the configuration to the SN. According to the MDT specifications, however, the SN execution of the configured MDT measurements is not tightly time aligned. They start upon the SN receiving the MDT configuration from the MN, and there is no mechanism for the MN to control the start of the SN's MDT measurements.

At best, the TCE/OAM receiving the signaling-based MDT measurements from MN and SN must correlate the MDT measurements from the respective nodes that are most proximate in time. This becomes more problematic when time alignment between MDT and QoE (including RVQoE) measurements is required. In this scenario, the network is not capable of aligning the QoE measurements performed by the UE and the signaling-based MDT measurements performed by the MN, SN, and the UE.

Likewise, management-based MDT measurements are not coordinated between a UE's MN and SN. Currently, when a first node (e.g., MN) receives a management-based MDT measurement it does not forward it to a second node (e.g., SN), and vice versa. The two nodes will perform and report their MDT measurements independently without any time alignment between their respective measurements-even if they relate to one or more UEs served by both nodes.

The TCE receives the measurements from both nodes and is unable to correlate them, even though such measurements are related to and/or collected by UEs served by both nodes (e.g., as MN and SN). Indeed, the trace reference (TR) and trace recording session reference (TRSR) associated with MDT measurements performed at a UE's MN and SN may be different, leaving the TCE with no means to even determine that the measurements relate to and/or were performed by the same UE. This becomes more problematic when time alignment between MDT and QoE (including RVQoE) measurements is required. In this scenario, the network is not capable of aligning the QoE measurements performed by the UE and the management-based MDT measurements performed by the MN, SN, and the UE.

Embodiments of the present disclosure address these and other problems, issues, and/or difficulties by providing flexible and efficient techniques for RAN nodes to perform MDT and QoE (including RVQoE) measurements in a time aligned way in multi-connectivity scenarios (e.g., DC). In other words, disclosed techniques facilitate MDT measurements collected at MN and SN for a UE in DC to be time aligned and correlation of such measurement by the TCE. When a UE is also performing QoE measurements, the MDT measurements are collected at MN and SN at approximately the same time as the QoE measurements, and the results are correlated by adding the MDT measurement identifiers to the QoE reports.

In some embodiments, a network node or function (e.g., CU-CP) maintains pending QoE measurement configurations receive from OAM/AMF as pending, and initiates MDT measurement execution/collection at all serving RAN nodes for the UE (e.g., MN and SN) upon receiving from the UE a QoE measurement start indication that is associated with one or more specific applications. Embodiments also include techniques to facilitate measurement time alignment when the MN and/or SN uses the split-node architecture described above.

In more detail, some embodiments address the need of achieving time alignment for MDT measurements at MN and SN in management-based MDT. In these embodiments, a first RAN node, which has received a management based MDT configuration and has selected a UE configured with DC for collection of MDT measurements, sends a message to a second RAN node that also serves the UE in DC. In this message, the first RAN node indicates that management-based MDT measurements are initiated for one or more UEs that are served by both first and second RAN nodes in DC. The second RAN node responds with a notification that MDT measurements have been configured and started for the one or more UEs identified or indicated by the message from the first RAN node. Additionally, the second RAN node provides to the first RAN node a trace reference (TR) and trace recording session reference (TRSR) associated with the MDT measurement collection process initiated for the one or more UEs.

Additionally, some embodiments enable a RAN node to time-align QoE (including RVQoE) measurements and MDT measurements related to UEs served by two RAN nodes in DC, wherein when the UE is configured with QoE (including RVQoE) measurements. There are different variants of these embodiments for signaling-based MDT and management-based MDT.

For signaling-based MDT, when the first RAN node (i.e., the UE's MN) receives a QoE measurement configuration and a signaling-based MDT measurement configuration (concurrently or separately), it refrains from sending the MDT configuration to the second RAN node (i.e., the UE's SN) until a triggering signal is received from the UE. For example, the triggering signal can be a session start indication for an application associated with the QoE measurement configuration. Upon receiving the triggering signal from the UE, the first RAN node sends the MDT configuration to the second RAN node and both nodes start performing the configured MDT measurements at approximately the same time. The second RAN node responds to the first RAN node with a TR and a TRSR associated with the MDT measurements performed by the second RAN node. The first RAN node combines this information to a received QoE report received from the UE, before sending the combined information to the MCE/TCE/OAM.

For management-based MDT, one difference is that the first RAN node does not signal the MDT configuration received from OAM to the second RAN node. Additionally, the MN and SN roles of the first and second RAN nodes can be varied. Otherwise, the procedures are similar with the identical goal of time alignment of MDT measurements at the first and second RAN nodes, as well as time alignment of these MDT measurements with QoE measurements performed by one or more UEs that are served by both first and second RAN nodes.

In this manner, by enabling RAN nodes arranged in DC with a single UE to perform MDT measurements in time aligned way with QoE measurements (including legacy and RVQoE measurements), embodiments facilitate easy correlation of these measurements by a collection entity. This can lead to detection, interpretation, and/or understanding of possible application-related issues and/or possible radio- and network-related issues. Availability of time aligned measurements in this manner can lead to improved network performance. Embodiments also provide these advantages when used in RAN nodes arranged in the split node architecture discussed herein.

In the following description of embodiments, the following groups of terms and/or abbreviations have the same or substantially similar meanings and, as such, are used interchangeably and/or synonymously unless specifically noted or unless a different meaning is clear from a specific context of use:
“application layer” and “UE application layer” (RAN nodes generally do not have an application layer);
“application-layer measurement”, “application measurement”, and “QoE measurement”;
“QoE measurement report”, “QoE report”, “measurement report”, and “report”;
“QoE measurement configuration”, QoE measurement and reporting configuration”, “QoE measurement”, “QoE configuration”, and “application layer measurement configuration”;
“modem”, “radio layer”, “radio network layer”, “access stratum”, and “AS”;
“MDT measurement”, “radio-layer measurement”, “radio measurement”, and “radio-related measurement”;
“radio layer connection” and “RRC connection”;
“linked”, “synched”, “synchronized”, “associated”, “time aligned”, and “coupled” with respect to application-layer (e.g., QoE) measurements and radio-layer (e.g., MDT) measurements;
“UE RRC configuration”, “RRC configuration”, “UE RRC context”, “RRC context”, “context”;
“service” and “application”;
“subservice type” and “service subtype”;
“measurement collection entity”, “MCE”, “trace collection entity”, and “TCE”;
“trace ID” and “NG-RAN trace ID”;
“signaling-based QoE/MDT” and “s-QoE/MDT”; and
“management-based QoE/MDT” and “m-QoE/MDT”.

The term “RAN visible QoE” (or “RVQoE”) may refer to RAN visible QoE measurements, RAN visible QoE measurement reporting, RAN visible QoE parameters and metrics, processing of information to derive RAN visible QoE parameters/metrics/information/data, and an overall framework for these and related activities. The term “RVQoE report” refers to a QoE report that includes RVQoE metrics and/or RVQoE values. An RVQoE report can be associated with one or more service types, one or more network slices, one or more service subtypes, one or more subservice types, etc.

As used herein, the term “conventional QoE metric” (or “legacy QoE metric”) refers to any of the QoE measurements specified in 3GPP TS 26.247 (v16.4.1), 26.114 (v16.7.0), 26.118 (v16.0.2), and 26.346 (v16.6.0) that are delivered from the UE to a network entity via the RAN, particularly when the RAN is unable to read the QoE reports containing the measured values of these metrics.

In contrast, the RAN is able to read, decode, understand, and/or interpret RVQoE metrics and/or RVQoE values included in QoE reports. The RVQoE metrics and values can be carried in information elements (IEs) of protocol messages, including RRC and inter-node signaling protocols. RVQoE metrics and values can be representations (e.g., in modified, adapted, or otherwise processed forms) of at least one conventional (or legacy) QoE metric as that term is defined above. Each representation can be condensed, compact, simplified, and/or more abstract with respect to the conventional QoE metric(s). For each, a RVQoE metric or value can require fewer information bits to transmit than corresponding conventional QoE metric(s).

As used herein, the term “QoE” (without any modifiers) refers generically to both legacy and RVQoE measurements, metrics, etc., unless expressly stated otherwise or clear from the particular context of use.

As used herein, the term “session” refers to a QoE measurement session, an application session, or an application session during which QoE measurements are performed, as the case may be. In general, a QoE measurement session typically coincides with a corresponding application session, but it is possible that a QoE measurement session starts a non-negligible time after the application session starts and/or ends a non-negligible time before the application session ends (i.e., while the application session is ongoing). The terms “session start”, “session end,” and “session stop” refer to the start, end, and stop of a QoE Measurement session.

As used herein, the terms “aligned,” “alignment,” “time aligned,” and “time-alignment” refer to MDT and QoE measurements that are performed substantially concurrently or during a common time period, or that start at approximately the same time. In some cases, a particular one of these meanings may be implied by the particular context of use.

In general, embodiments disclosed herein are applicable to both signaling- and management-based MDT and QoE measurements. In addition, embodiments disclosed herein are applicable to UEs and RANs used in UMTS, LTE, and NR.

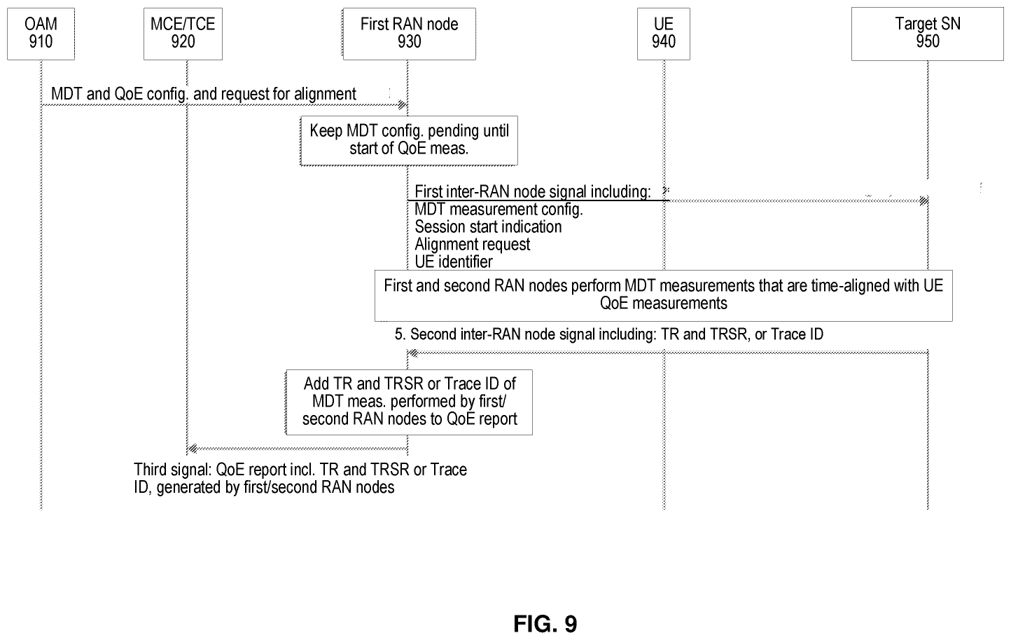

FIG. 9 shows a signaling diagram of a technique to control start/execution of MDT measurements in DC scenarios when the alignment of MDT and QoE measurements is requested by the OAM, according to various embodiments of the present disclosure. In the arrangement shown in FIG. 9, the first RAN node triggers the MDT measurements at the second RAN node upon receiving an MDT configuration from OAM and upon selecting a UE for the MDT measurements that is served by both first and second RAN nodes (e.g., in DC). The operations shown in FIG. 9 are described as follows.

Initially, OAM signals to the first RAN node a management based MDT configuration. Optionally, the OAM may signal an indication that alignment of MDT measurements for UEs in DC is required. The first RAN node selects a UE for the received MDT measurement configuration. The first RAN node is aware that the selected UE is served by a second RAN node as part of a DC configuration. Note that the first RAN node may be the UE's MN or SN.

The first RAN node sends to the second RAN node a message (labeled “first inter-RAN node signa”) that includes one or more of the following:
one or more identifiers pertaining to the MDT measurements collected at the first RAN node, e.g., TRSR, TR, Trace ID, etc.
one or more UE identifiers, such as the application protocol IDs used for the UE for inter RAN node signaling over Xn or X2 interface.
indication to trigger MDT measurements for the identified UE.
indication of the MDT measurements that are collected at the first RAN node for the identified UE.
time alignment request for measurements collected at the second RAN node.
indication of start time for first RAN node MDT measurements for the UE, e.g., in absolute time (e.g., UTC or system frame number) or relative to some signaling event between first and second RAN nodes. In some cases, the second RAN node may be aware of propagation delay over the inter-RAN node interface such that it can determine with sufficient accuracy the time at which MDT measurements were started at the first RAN node.

Subsequently, the first and second RAN nodes perform MDT measurements for the same UE. The two nodes may collect the same or different measurements for the UE, but preferably the measurements collected by the two RAN nodes are time aligned. The second RAN node sends to the first RAN node a message (labeled “second inter-RAN node signal”) including an indication that the second RAN node performed the MDT measurements in alignment with those performed by the first RAN node. The message from second RAN node also includes one or more of the following identifiers pertaining to the MDT measurement collection at the second RAN node: TRSR, TR, and Trace ID.

The first RAN node adds the information received from the second RAN node to the MDT measurement report comprising the MDT measurements performed by the first RAN node (or a representation thereof), including measurements for the selected UE. The first RAN node sends the MDT measurement report to the TCE (labeled “third signal”). The MDT measurement report may also include QoE measurements performed by the UE in time alignment with the MDT measurements, and collected by the first RAN node from the UE (not shown). Thus, the report sent to the TCE may also be referred to as a “QoE report”.

The TCE may also receive MDT measurement reports from the second RAN node as part of a corresponding MDT measurement reporting process. The TCE can correlate the MDT measurements received from both RAN nodes based on the identifiers provided by the second RAN node and included in the MDT measurement report by the first RAN node. Such identifiers point at the measurement collection process run, for the same UE, by the second RAN node. Additionally, the second RAN node may include in its MDT measurement report the measurement identifiers that it received from the first RAN node (e.g., TR and TRSR). By correlating MDT measurements for the same UE, collected at the first and second RAN nodes, the TCE can perform a complete performance analysis of the DC configuration for that UE.

The solution described above pertains to management-based MDT and non-split RAN node architecture. However, either or both of the first and second RAN nodes (e.g., gNB) may be split two ways into CU and DU(s) or three ways into CU-CP, CU-UP, and DU(s), each of which may perform MDT measurements. In general, embodiments of the present disclosure concern operations performed by the CU or CU-CP, depending on split. According to 3GPP TS 38.401 (v16.9.0), management-based MDT measurements in a split RAN node may be activated in one of the following ways:
CU-CP/CU receives MDT configuration and decides whether and which DU and/or CU-UP(s) to involve in the measurements; or
OAM sends MDT measurement configuration to CU-CP/CU/DU or CU-CP/CU-UP/DU directly.
   According to 3GPP TS 38.401 (v16.9.0), each node involved in the MDT measurement reports collected measurements directly to the TCE indicated by the received measurement configuration.

In the context of the procedure shown in FIG. 9, if the first RAN node (e.g., CU-CP) decides that its associated DU and/or CU-UP serving the UE should be involved in the MDT measurements, it can send the serving DU and/or CU-UP any of the same information that it sent to the second RAN node (e.g., in the first inter-RAN node signal). Optionally, the OAM may signal an indication that alignment of MDT measurements for UEs in DC is required (this is proposed in the solution above). The first RAN node also sends to the second RAN node an indication of whether its associated DU and/or CU-UP serving the UE are involved in the MDT measurements.

Upon receiving the information from the first RAN node, the second RAN node decides whether its associated DU and/or CU-UP serving the UE should be involved in the MDT measurements. If so, the second RAN node configures these entities for the relevant MDT measurements and also sends to these entities relevant parts of the received information (e.g., Trace IDs, TRSR, TR) concerning the first RAN node's MDT measurements.

Upon receiving the information about the second RAN node's MDT measurements (e.g., Trace IDs, TRSR, TR), the first RAN node forwards relevant parts of the received information to its associated DU and/or CU-UP serving the UE that are involved in the first RAN node's measurements. in addition to the first and second RAN nodes (i.e., CU-CPs), all other entities (e.g., DUs, CU-UPs) involved in the MDT measurements pertaining to the UE send their respective measurement reports to the OAM/TCE directly, such as described above in relation to FIG. 9.

FIG. 10 shows a signaling diagram of a technique to control start/execution of MDT measurements in DC scenarios when the alignment of MDT and QoE measurements is requested by the OAM, according to various embodiments of the present disclosure. In the arrangement shown in FIG. 10, the first RAN node triggers the MDT measurements at the second RAN node upon receiving an indication from a UE concerning an application-layer event at the UE (e.g., a session start indication). The operations shown in FIG. 10 are described as follows.

The first RAN node (e.g., UE's MN in DC) receives at least one QoE measurement configuration and zero or more MDT measurement configuration(s) from another network entity such as OAM, CN (e.g., AMF), or a third RAN node. At least one received configuration includes an indication to perform time aligned QoE and MDT measurements. At a high level, the UE initiates the QoE measurements and sends a session start indication to the first RAN node, upon which the first RAN node sends the MDT measurement configuration to the second RAN node, together with other information that facilitates time alignment (described below).

For example, the first RAN node receives one QoE measurement configuration and one MDT measurement configuration, and the QoE measurement configuration includes (or is accompanied by) an indication to align the configured QoE and MDT measurements.

As another example, the first RAN node receives one QoE measurement configuration but no MDT measurement configuration, and the QoE measurement configuration includes (or is accompanied by) an indication to align the QoE measurements with any MDT measurements. The first RAN node then selects an MDT measurement configuration to align with the QoE measurement configuration. The QoE configuration and the selected m-MDT configuration should pertain to one or more UEs being served by both the first and second RAN nodes in DC. In other words, both the first and second RAN nodes serving the UE should be within the area scope of the received QoE configuration and the selected MDT configuration.

In some embodiments, at least one of the received configurations may include (or be accompanied by) an implicit or explicit indication of time-alignment for DC. For example, OAM requests alignment of QOE and MDT measurements for a UE in a multi-connectivity (e.g., DC).

In some embodiments, at least one of the received configurations may include explicit or implicit indications of type(s) of multi-connectivity arrangements for which time alignment is possible, desirable, mandated, allowed, or prohibited, optionally including additional criteria to determine when time alignment is possible, desirable, mandated, allowed, or prohibited.

As one example, one or more service types listed in the QoE measurement configuration can be used to indicate and/or determine whether alignment between QoE and MDT measurements is possible only when MN and SN use same RAT for serving the UE (e.g., LTE-DC or NR-DC), or only when both MN and SN are connected to a particular CN (e.g., 5GC).

In some embodiments, at least one of the received configurations may include (or be accompanied by) an implicit or explicit indication that alignment should be performed only when an application session associated with the QoE measurement is associated with a particular network slice (or a set of network slices) for which alignment is allowed. The particular network slice(s) may be indicated by one or more S-NSSAI. The concerned network slice (or set of network slices) may also refer to a network slice (or set of network slices) indicated in the QoE configuration (using one or more S-NSSAI(s)). Alternatively, at least one of the received configurations may include (or be accompanied by) an implicit or explicit indication that alignment should be performed only for UE(s) in DC in specific cells (e.g., NR CGIs), PLMNs, tracking areas, etc.

In some embodiments, the first RAN node may receive multiple MDT measurement configurations, one per radio access technology (RAT). For example, if alignment of QoE and MDT is desired for MR-DC, the first network node can receive one MDT measurement configuration for LTE and a second for NR.

In some embodiments, if a received MDT measurement configuration is for management-based MDT, the first RAN node generates a TRSR associated with the received MDT measurement configuration. Alternatively, the first RAN node may postpone TRSR generation until it starts the configured MDT measurements or until it receives an indication of an event (e.g., a UE session start indication) that triggers start of the MDT measurements.

The first RAN node sends a QoE configuration to the UE and configures the UE to send session status (e.g., session start/end indications) for QoE measurement sessions associated with the QoE configuration. The first RAN node also maintains the received or selected MDT configuration in memory while waiting for an event that triggers start of the MDT measurements, such as a UE session start indication (or other session status change) for an application associated with and/or relevant to the QoE configuration. Alternately, an event may be an indication of the start of a UE QoE measurement session associated with the QoE configuration.

In some embodiments, the first RAN node sends the MDT configuration to the second RAN node upon receiving an explicit or implicit indication that an RVQoE measurement has started. This applies to RVQoE measurement starts due to application session start and event triggered RVQoE measurements.

At some point, in operation 3, the first RAN node receives from the UE an indication of an application-layer event, such as the session start indication mentioned above. If the MDT measurement configuration is management-based and the first RAN node did not previously generate an associated TRSR, it does so at this time or after receiving a QoE report from the UE (discussed below).

The first RAN nodes sends the UE the relevant parts of the MDT configuration. The UE should use this MDT configuration as an immediate MDT measurement configuration, to facilitate alignment between the QoE and MDT measurements in accordance with the alignment indication/instruction received from the OAM or CN. In some embodiments, when the first and second RANs node use respective first and second RATs to serve the UE (e.g., EN-DC or MR-DC), and the first RAN node received an MDT configuration applicable to the second RAT, the first RAN node may send the relevant MDT configuration for the second RAT to the UE together with the relevant MDT configuration for the first RAT.

In some embodiments, if the first RAN node previously received the MDT configuration before receiving the QoE configuration, the first RAN node may omit sending the MDT configuration to the UE at this point.

The first RAN node starts MDT measurements in accordance with the received MDT measurement configuration(s). If the concerned MDT measurement configuration is management-based and the first RAN node did not generate an associated TRSR earlier, it can do so at this point. In operation 4, the first RAN node sends a first inter-RAN node signal to a second RAN node (e.g., a TRACE START XnAP message) including one or more of the following:
an MDT measurement configuration, or relevant parts thereof (e.g., list of MDT measurements that are collected for the UE at the first RAN node);
one or more identifiers pertaining to the MDT measurements collected at the first RAN node, e.g., TRSR, TR, Trace ID, etc.
one or more UE identifiers, such as the application protocol IDs used for the UE for inter RAN node signaling over Xn or X2 interface.
indication of UE application-layer event associated with time aligned QoE measurements (e.g., session start indication);
time alignment request for QoE and MDT measurements (e.g., as received from CN or OAM), or other indication that triggers the second RAN node to provide information about MDT measurements performed by second RAN node;
indication of start time for first RAN node MDT measurements for the UE, e.g., in absolute time (e.g., UTC or system frame number) or relative to some signaling event between first and second RAN nodes. In some cases, the second RAN node may be aware of propagation delay over the inter-RAN node interface such that it can determine with sufficient accuracy the time at which MDT measurements were started at the first RAN node.

In some embodiments, the alignment request may be for the second RAN node to align with any MDT measurement configuration available at the second RAN node (including any MDT measurement configuration or part thereof sent by the first RAN node).

In one example scenario involving management-based immediate MDT measurements, the first RAN node may send only the indication of UE application-layer event received from the UE.

In another example scenario involving signaling-based immediate MDT measurement, the first RAN node may send all of the above-listed information to the second RAN node.

In another example, the second RAN node interprets the information received from the first RAN node as a request for immediate execution of the MDT measurement at the second RAN node, and performs accordingly. In other words, sending this information implies aligned execution/performing of the MDT measurements at the first and second RAN nodes together (in parallel) with the QoE measurements at the UE.

The second RAN node upon receiving the first inter-RAN node signal from the first RAN node, selects the indicated UE based on the signaled UE identifier and performs the MDT measurements according to the provided MDT configuration. The second RAN node also produces a TRSR if needed (e.g., in case of management-based MDT).

In some variants, the first RAN node receives first and second MDT configurations pertaining to respective first and second RATs (e.g., LTE and NR) and it sends the second RAN node the MDT configuration (i.e., first or second) pertaining to the RAT used by the second RAN node to serve the UE. In other variants, the first RAN node receives one MDT configuration pertaining to a first RAT used by the first RAN node, and selectively sends this MDT configuration to the second RAN node depending on whether the second RAN node uses the same RAT to serve the UE.

As an alternative, when the second RAN node uses the second RAT, the first RAN node can translate the received MDT configuration into a form that is suitable for the second RAT, and send the translated MDT configuration to the second RAN node. As another alternative, the first RAN node can send the received MDT configuration to the second RAN node, anticipating that the second RAN node can translate the MDT configuration into a form suitable for the second RAT used by the second RAN node.

In some embodiments, whether to send the MDT configuration to the second RAN node may depend on configuration information in the first RAN node. This configuration information may include an indication of the second RAN node's ability to translate an MDT configuration. Such configuration information may have been conveyed to the first RAN node by OAM, by CN, or by second RAN node.

In other variants, the first RAN node receives one MDT configuration pertaining to a second RAT used by the second RAN node. The first RAN node sends the received MDT configuration to the second RAN node, and also translates the received MDT configuration to a form applicable to the first RAT used by the first RAN node. The first RAN node may perform MDT measurements in accordance with this translated MDT configuration and may also send translated MDT configuration to the UE.

In other variants, the first RAN node receives one MDT configuration applicable to any RAT. However, the QoE configuration is associated with a service type only applicable to a first RAT. For example, the first RAN node is an NR node and the QoE configuration indicates to collect measurements for Augmented Reality (AR), which is only applicable to NR. The first RAN node uses the “service type” in the QoE configuration as an input to determine to send the MDT configuration to the second RAN node.

In an EN-DC arrangement where the first RAN node is an LTE MN, the second RAN node is an NR SN, and the QoE configuration targets service type AR, the first RAN node sends the MDT configuration to the second RAN node. In an NE-DC arrangement where the first RAN node is an NR MN, the second RAN node is an LTE SN and the QoE configuration targets service type AR, the first RAN node may choose not to send the MDT configuration to the second RAN node.

In some embodiments, the same MDT measurement may be configured both for alignment with QoE measurements and for providing MDT measurement data independently of QoE measurements. Hence, it may be useful to send the MDT configuration to the second RAN node even when the second RAN node uses LTE and the QoE measurements target NR-associated service type such as AR. In such a case, the first RAN node would send neither an alignment indication nor an indication to trigger the second RAN node to respond with TRSR, and the first RAN node would not send TRSR of the second RAN node with the QoE report (see below).

In operation 5, the first RAN node receives a second inter-RAN node signal from the second RAN node including TRSR, TR, and/or Trace ID pertaining to the MDT measurement session triggered at the second RAN node. The second inter-RAN node signal may also contain a UE identifier associated with the inter-RAN node interface (e.g., M-NG-RAN node UE XnAP ID)

In some embodiments, the second RAN node includes TRSR but neither TR nor Trace ID. This option may be used if the second inter-RAN node signal can be associated with the first inter-RAN node signal in operation 4. Such association may be achieved, for example, by including a common transaction identifier in both signals, or by specifying that the pair of signals constitutes a procedure and that only one such procedure can be ongoing at any one time between the RAN nodes.

In other embodiments, for alignment of the QoE measurement with signaling-based MDT, the second RAN node sends the Trace ID associated with the MDT configuration to the first RAN node. In other embodiments, for alignment of the QoE measurement with a management-based MDT, the second RAN node sends TR and TRSR associated with the MDT configuration to the first RAN node.

In operation 6, the first RAN node receives from the UE an application layer measurement report (e.g., a MeasurementReportAppLayer RRC message) including a QoE measurement report associated with the QoE measurement configuration sent to the UE in operation 2.

In some embodiments, the first RAN node can receive from the UE a second indication of a second UE application-layer event pertaining to the QoE measurements, e.g., a session end indication referring to the end of a QoE measurement session or the end of an application session with an associated QoE measurement session. The first RAN node sends an indication to the second RAN node to terminate the MDT measurements and/or release the MDT measurement configuration. In addition, upon receiving the second indication from the UE, the first RAN node terminates its MDT measurements and/or release its MDT measurement configuration.

In operation 7, the first RAN node can append the information received from the second RAN node in operation 5 to the QoE measurement report received from the UE in operation 6. In some embodiments, the first RAN node also appends identifiers (e.g., TRSR, TR, and/or Trace ID) associated with the MDT measurements performed by the first RAN node and/or by the second RAN node. Some examples of appended information include:
a TRSR generated by the second RAN node and associated with MDT measurements performed by the second RAN node (in accordance with the MDT measurement configuration(s) received in operation 1),
a TRSR generated by the first RAN node and associated with MDT measurements performed in the first RAN node (in accordance with the MDT measurement configuration(s) received in operation 1), and
one of the following:
   one TR that is common for the MDT measurements performed in the first RAN node and the MDT measurements performed in the second RAN node, or
   two TRs, one associated with the MDT measurements performed in the first RAN node and the other associated with the MDT measurements performed in the second RAN node.
      In some embodiments, the first RAN node can also append an indication of the RAT(s) associated with the MDT measurements performed by the first RAN node and/or by the second RAN node. In general, these “appending” operations should be understood as different than incorporating or including within.

In operation 8, the first RAN node sends the TCE/MCE/OAM the QoE report together with the information appended in operation 7.

In general, the operations performed by the second RAN node in FIG. 10 are complementary to the operations performed by the first RAN node. However, some additional aspects or features are described below.

After receiving the information from the first RAN node in operation 4 (“first inter-RAN node signal”), the second RAN node starts MDT measurements in accordance with the received information. If the first inter-RAN node signal included an MDT measurement configuration, the second RAN node starts MDT measurements configured by the received MDT measurement configuration. If the first inter-RAN node signal did not include an MDT measurement configuration but included an identifier of an MDT measurement configuration, the second RAN node starts MDT measurements the second RAN node starts MDT measurements configured by the identified MDT measurement configuration.

This second case is most likely to occur for management-based MDT measurement configurations, which may have already been received by the second RAN node. In some cases, when the identified MDT measurement configuration is a management-based MDT configuration that was already received from OAM, the second RAN node may have already selected the UE indicated by the first RAN node as one of the MDT targets and started the configured MDT measurements, before receiving the first inter-RAN node signal from the first RAN node.

If the first inter-RAN node signal included an indication or a request to align with any MDT measurement configuration, the second RAN node may select an available MDT measurement configuration (including an MDT measurement configuration received in the first inter-RAN node signal) and start the corresponding MDT measurements. The second RAN node may also send the selected MDT measurement configuration (or the relevant parts thereof) to the UE. In some embodiments, the second RAN node can condition sending the selected MDT measurement configuration to the UE upon the second RAN node using a different RAT to serve the UE than the first RAN node uses to serve the UE.

In various embodiments, the second RAN node can generate a TRSR for identification of the MDT measurements initiated by the second RAN node, or for identification of the MDT configuration that configured these MDT measurements.

In some embodiments, the second RAN node may generate a TRSR when the first inter-RAN node signal included a TR but no TRSR or when the first inter-RAN node signal included no MDT related identifiers (e.g., no TRSRs, TRs, or Trace IDs). If the second RAN node's MDT measurements were initiated before the second RAN node received the first inter-RAN node signal, the second RAN node may reuse a measurement identification generated at time of initiation. If the same MDT identification is used for the MDT measurements in both the first RAN node and the second RAN node (e.g., if the first inter-RAN node signal included Trace ID or TR and TRSR), the second RAN node may omit generating an identification of the initiated MDT measurements.

In some embodiments, the second RAN node may combine a generated TRSR with a TR received from the first RAN node, OAM, or CN to form a Trace ID.

In operation 5, the second RAN node sends the second inter-RAN node signal to the first RAN node. This signal can have any of the contents discussed above in relation to the first RAN node receiving this signal in operation 5. For example, the second RAN node can include a TRSR that it generated, as discussed above.

Although not shown in FIG. 10, after completing the time aligned QoE and MDT measurements, the second RAN node can send a QoE report to the TCE/MCE/OAM, together with various appended information. For example, the information appended by the second RAN node can be any of the types of information appended by the first RAN node to the QoE report sent in operation 8.

In the procedure shown in FIG. 10, either or both of the first and second RAN nodes (e.g., gNB) may be split two ways into CU and DU(s) or three ways into CU-CP, CU-UP, and DU(s), each of which may perform MDT measurements. According to 3GPP TS 38.401 (v16.9.0), each node involved in the MDT measurement reports collected measurements directly to the TCE indicated by the received measurement configuration.

In the procedure shown in FIG. 10, if the first RAN node (e.g., CU-CP) decides that its associated DU and/or CU-UP serving the UE should be involved in the MDT measurements, it can send the serving DU and/or CU-UP any of the same information that it sent to the second RAN node (e.g., in the first inter-RAN node signal). The first RAN node also sends to the second RAN node an indication of whether its associated DU and/or CU-UP serving the UE are involved in the MDT measurements.

Upon receiving the information from the first RAN node, the second RAN node decides whether its associated DU and/or CU-UP serving the UE should be involved in the MDT measurements. If so, the second RAN node configures these entities for the relevant MDT measurements and also sends to these entities relevant parts of the received information (e.g., Trace IDs, TRSR, TR) concerning the first RAN node's MDT measurements.

Upon receiving the information about the second RAN node's MDT measurements (e.g., Trace IDs, TRSR, TR), the first RAN node forwards relevant parts of the received information to its associated DU and/or CU-UP serving the UE that are involved in the first RAN node's measurements. in addition to the first and second RAN nodes (i.e., CU-CPs), all other entities (e.g., DUs, CU-UPs) involved in the MDT measurements pertaining to the UE send their respective measurement reports to the OAM/TCE directly.

In some embodiments, the first inter-RAN node signal (e.g., FIG. 10 operation 3) includes information for performing MDT measurements and QoE measurements in aligned way for a plurality of UEs selected for time aligned MDT and QoE measurements. The information can be arranged, for example, as a first list of information elements (IEs), one IE per UE selected.

In some embodiments, the second inter-RAN node signal (e.g., FIG. 10 operation 4) includes information (e.g., TR, TRSR, and/or Trace ID) about time aligned MDT measurements performed by the second RAN node for a plurality of UEs. The information can be arranged, for example, as a second list of information elements (IEs), one IE per UE selected. The UEs associated with the second list can be the same or different than UEs associated with the first list.

In some embodiments, a UE may initially be operating in single connectivity with the first RAN node when time aligned QoE and MDT measurements are initially triggered. A second RAN node may later be added as SN for DC, after which the second RAN node is informed of the ongoing time aligned QoE and MDT measurements. FIG. 11 shows a signaling diagram of a technique to control start/execution of MDT measurements in DC scenarios when the alignment of MDT and QoE measurements is requested by the OAM, according to various embodiments of the present disclosure. In the arrangement shown in FIG. 11, the UE is initially operating in single connectivity but later adds an SN for DC, all while time aligned QoE/MDT measurements are ongoing.

For example, the first RAN node may add the second RAN node as SN by sending an S-NODE ADDITION REQUEST message to the second RAN node. The MDT measurement configuration may be provided to the second RAN node at time of SN setup (e.g., in the S-NODE ADDITION REQUEST message) or after setup as shown in FIG. 11 (e.g., in the message labeled “first inter-RAN signal”). In either case, the first RAN node can send the UE one or more of the following pertaining to the ongoing measurements: TRSR, TR, Trace ID, and UE identifier (e.g., related to inter-RAN node interface). The first RAN node can also indicate which MDT measurements are activated (e.g., M5). This is similar to other embodiments described above.

In case the first and second RAN nodes are split nodes, the first RAN node (i.e., CU or CU-CP) indicates to the second RAN node (i.e., CU-CP) whether its associated DU and/or CU-UP serving the UE are involved in the first RAN node's ongoing MDT measurements. According to 3GPP TS 38.401 (v16.9.0), in split RAN architecture, the CU/CU-CP decides on its own which nodes to involve in the MDT measurements, so the indication is intended to address the case where both RAN nodes are split, such that the same entities in both RAN nodes can perform the same or complementary MDT measurements (e.g., DUs serving the UE under first and second RAN nodes).

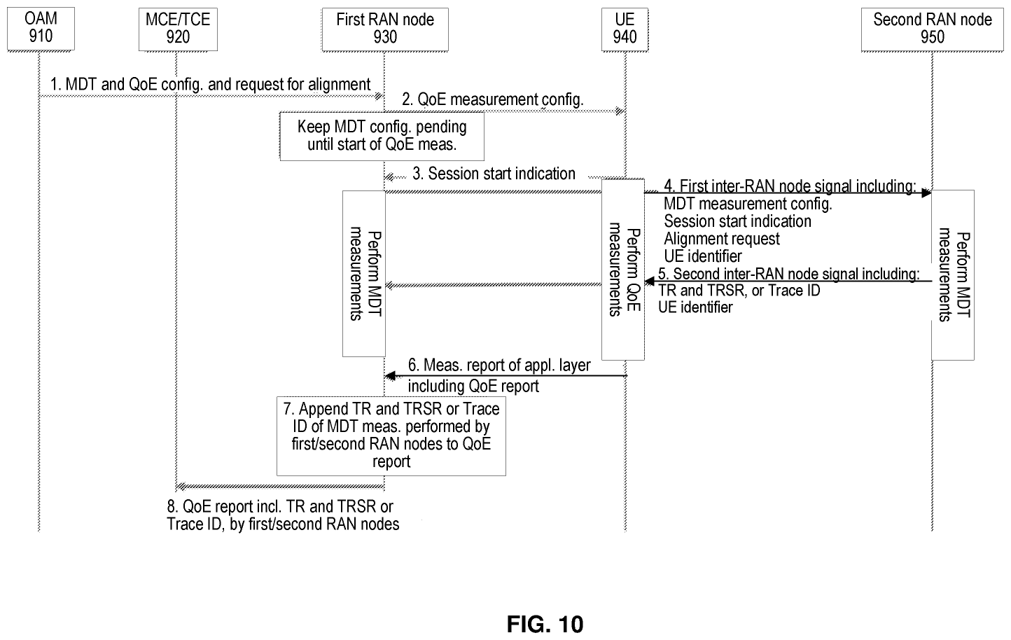

FIG. 12A-B shows a signaling diagram of a technique to control start/execution of MDT measurements in DC scenarios when the alignment of MDT and QoE measurements is requested by the OAM, according to various embodiments of the present disclosure. In the arrangement shown in FIG. 12A-B, the UE is first connected to a source SN but after a PSCell change is connected to a target SN, all while time aligned QoE/MDT measurements are ongoing.

In this scenario, the source SN (second RAN node) needs to forward the information about the time aligned measurements to a target SN (new second RAN node). The forwarded information may include relevant information received from the first RAN node, as well as additional information such as UE QoE configuration, UE MDT configuration, UE session status, UE identifier, Trace ID, TRSR, recording session ID, etc. The information may be sent in inter-node messages such as S-NODE CHANGE REQUIRED, S-NODE ADDITION REQUEST, S-NODE CHANGE REQUEST, S-NODE MODIFICATION REQUEST, etc.

In case the target SN is a split node, after the target CU (or CU-CP) decides which other RAN node entities under its control should be involved in the measurements, it forwards relevant parts of the information received from the first RAN node to these other RAN node entities that should be involved in the measurements.

Some embodiments of the present disclosure are based on activation of configured but inactive MDT measurements in the SN, e.g., second RAN node. In this scenario, a first RAN node (e.g., UE's MN) receives from OAM or CN a QoE measurement configuration, an MDT measurement configuration, and an indication that these measurements should be time aligned. This information may be received together or separately.

In some embodiments, the first RAN node does not withhold the MDT measurement configuration from the second RAN node as in other embodiments described above, Rather, the first RAN node forwards the MDT measurement configuration (or relevant parts) to the second RAN node immediately after receiving it, and instructs the second RAN node to maintain the MDT measurement configuration in an inactive state, during which the second RAN node does not initiate any associated MDT measurements. As discussed above, the first RAN node can also forwards the received QoE measurement configuration to the UE.

When the first RAN node subsequently receives a session start indication from the UE (or an indication of another event that should trigger start of the time aligned MDT measurements), the first RAN node starts its MDT measurements according to the received MDT measurement configuration and sends to the second RAN node a command or instruction to activate the inactive MDT measurement configuration and to initiate the MDT measurements accordingly. The second RAN node may return one or more identifiers (e.g., TR, TRSR, Trace ID) associated with the MDT measurement configuration or the MDT measurements in the second RAN node, in response to either receiving the MDT measurement configuration or receiving the activation command.

As described above, when the first RAN node receives from the UE a QoE measurement report associated with the QoE measurement configuration, the first RAN node forwards the QoE report to the configured receiver of the QoE report (e.g., an MCE) together with the identifiers associated with the aligned MDT measurements in the first RAN node and in the second RAN node. Alternatively, if the second RAN node receives the QoE reports from the UE, the second RAN node includes the identifiers associated with the aligned MDT measurements in the first RAN node and in the second RAN node.

Furthermore, when the first RAN node receives from the UE a second indication that the QoE measurement session has ended (e.g., session end/stop indication or a QoE measurement report sent upon conclusion of an application session), the first RAN node may send the second RAN node a command or instruction to inactivate, delete, and/or release the MDT measurement configuration.

When the second RAN node receives such a command, the second RAN node stops any associated ongoing MDT measurements and inactivates, deletes, and/or releases the MDT measurement configuration. For example, inactivating may be done by setting a state variable associated with the MDT measurement configuration to “inactive”. If not deleted or released, an inactivated MDT measurement configuration may subsequently be reactivated, e.g., by an activation command from the first RAN node as described above.

When the second RAN node receives an instruction to delete or release the MDT measurement configuration, the second RAN node stops any associated ongoing MDT measurements deletes/releases the MDT measurement configuration regardless of whether the concerned MDT measurement configuration was active or inactive when the command was received.

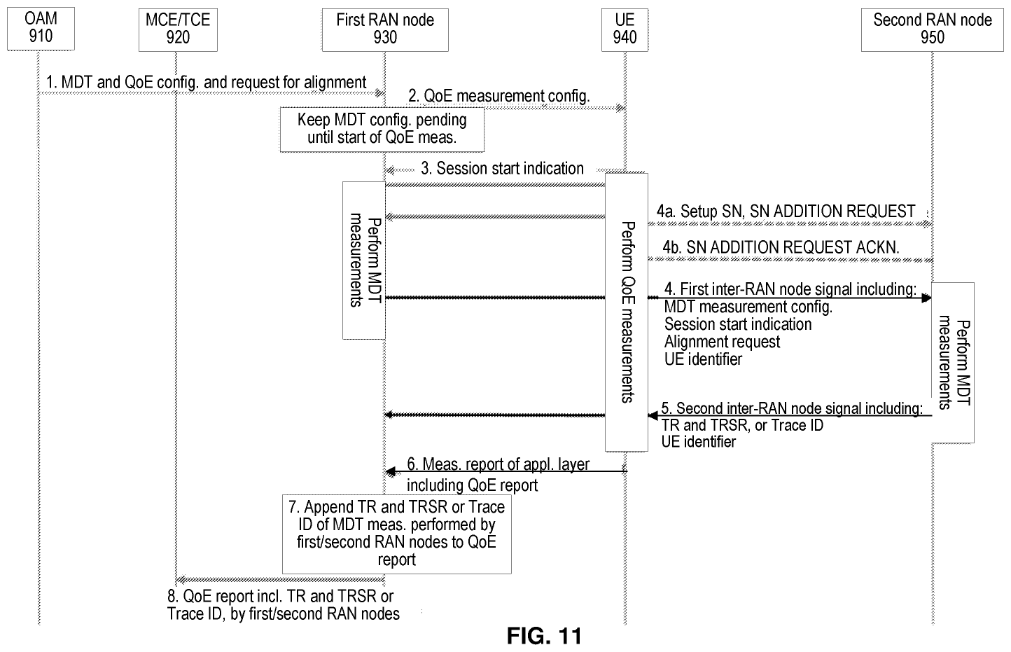

Various features of the embodiments described above correspond to various operations illustrated in FIGS. 13-15, which show exemplary methods (e.g., procedures) for a first RAN node, a second RAN node, and a measurement collection node or function (MCNF), respectively. In other words, various features of the operations described below correspond to various embodiments described above. Furthermore, the exemplary methods shown in FIGS. 13-15 can be used cooperatively to provide various benefits, advantages, and/or solutions to problems described herein. Although FIGS. 13-15 show specific blocks in particular orders, the operations of the exemplary methods can be performed in different orders than shown and can be combined and/or divided into blocks having different functionality than shown. Optional blocks or operations are indicated by dashed lines.

In particular, FIG. 13 shows an exemplary method (e.g., procedure) for a first RAN node configured to provide dual connectivity (DC) for a UE together with a second RAN node, according to various embodiments of the present disclosure. The exemplary method can be performed by a RAN node (e.g., gNB or unit or function thereof, such as CU-CP) such as described elsewhere herein.

The exemplary method can include the operations of block 1310, where the first RAN node can receive from another node or function associated with the RAN a measurement configuration that includes a first configuration for QoE measurements and an indication that the QoE measurements and should be time aligned with MDT measurements. The exemplary method can also include the operations of block 1320, where the first RAN node can send the first configuration to a UE. The exemplary method can also include the operations of block 1330, where the first RAN node can receive from the UE a first indication that an event associated with the QoE measurements has occurred. The exemplary method can also include the operations of block 1340, where in response to the first indication, the first RAN node can initiate first MDT measurements and send to the second RAN node a command to initiate MDT measurements that are time aligned with the QoE measurements associated with the first configuration.

In some embodiments, the other node or function associated with the RAN is one of the following: an OAM node coupled to the RAN; or a node or function of a core network (CN) coupled to the RAN. In some embodiments, the first indication is one of the following: a session start indication for a UE application session having characteristics related to the first configuration; or a session start indication for a UE QoE measurement session associated with the first configuration. In some embodiments, the first configuration is for RAN-visible QoE measurements.

In some embodiments, the measurement configuration also includes a second configuration for MDT measurements and the indication also indicates that the QoE measurements should be time aligned with the MDT measurements associated with the second configuration.

In some of these embodiments, the exemplary method also includes the operations of block 1315, where the first RAN node can store the second configuration upon receipt, such that the first MDT measurements are initiated (e.g., in block 1340) according to the stored second configuration.

In some of these embodiments, at least a portion of the second configuration is sent to the UE together with the first configuration. In some of these embodiments, one of the first configuration and the second configuration includes an indication of the event associated with the QoE measurements. In some of these embodiments, one or more of the following information is sent to the second RAN node together with the command:
at least a portion of the second configuration;
one or more identifiers of the first MDT measurements;
a start time for the first MDT measurements;
one or more UE identifiers;
the first indication received from the UE, or a representation thereof; and
an indication or request for the second RAN node to provide information about second MDT measurements performed by second RAN node.
   Different variants of these embodiments are described below.

In some variants, the second configuration is associated with a first radio access technology (RAT). In some of these variants, the at least a portion of the second configuration is included with the command when the second RAN node uses the first RAT to serve the UE. In other of these variants, the at least a portion of the second configuration is included with the command when the second RAN node uses a second RAT to serve the UE. In other of these variants, the exemplary method also includes the operations of block 1335, where the first RAN node can translate the second configuration into a form suitable for a second RAT used by the second RAN node to serve the UE. Subsequently, the form suitable for the second RAT is included with the command (e.g., in block 1340).

In other variants, the first configuration includes a service type associated with the QoE measurements, and the at least a portion of the second configuration is included with the command when the second RAN node serves the UE with a RAT that supports the service type. In other variants, one of the following is also sent to the second RAN node together with the command to initiate MDT measurements:
a command to add the second RAN node as the UE's SN for DC; or
a command to change the UE's SN from a third RAN node to the second RAN node.

In other of these embodiments, the second configuration includes two second configurations, one associated with a first RAT and another associated with a second RAT. The MDT measurements are initiated according to the second configuration associated with the second RAT, and at least a portion of the second configuration associated with the second RAT is sent to the second RAN node together with the command.

In some of these embodiments, the method is performed by a centralized unit control plane (CU-CP) of the first RAN node and also includes the following operations, labelled with corresponding block numbers:
(1325) sending, to one or more units or functions of the first RAN node, the second configuration together with a command to maintain the second configuration in an inactive state; and
(1345) in response to the first indication, sending to the one or more units or functions of the first RAN node a command to activate the second configuration.

In such embodiments, the one or more units or functions of the first RAN node include one of more of the following: a CU-UP, and one or more DUs.

In other embodiments, an identifier of a second configuration for MDT measurements is sent to the second RAN node together with the command. In such case, the command indicates that the second RAN node should initiate second MDT measurements according to the identified second configuration.

In some embodiments, the exemplary method can also include the following operations, labelled with corresponding block numbers:
(1360) receiving from the UE a QoE report comprising results of QoE measurements performed according to the first configuration;
(1380) appending, to the QoE report, MDT-related information including one or first more identifiers of the first MDT measurements; and
(1390) sending the QoE report with the appended MDT-related information to a measurement collection node or function (MCNF) associated with the RAN.

In some of these embodiments, the exemplary method can also include the operations of block 1370, where the first RAN node can stop the first MDT measurements. In some of these embodiments, the exemplary method can also include the operations of block 1350, where the first RAN node can receive from the second RAN node one or more second identifiers of second MDT measurements initiated by the second RAN node responsive to the commands. In such embodiments, the MDT-related information appended to the QoE report also includes the one or more second identifiers. In some variants, each second identifier is one of the following: a Trace Recording Session Reference (TRSR), a Trace Reference (TR) and a TRSR, or a Trace identifier (ID).

In some embodiments, the exemplary method can also include the operations of block 1365, where in response to receiving from the UE a second indication that the QoE measurements have stopped or ended, the first RAN node can send one of the following commands to the second RAN node: a command to release the second configuration; or a command to maintain the second configuration in an inactive state. In various embodiments, the second indication can be any of the following:
implicit from receiving the QoE report (e.g., in block 1360);
an explicit session stop indication for a UE application session having characteristics related to the first configuration; or
an explicit session stop indication for a UE QoE measurement session associated with the first configuration.

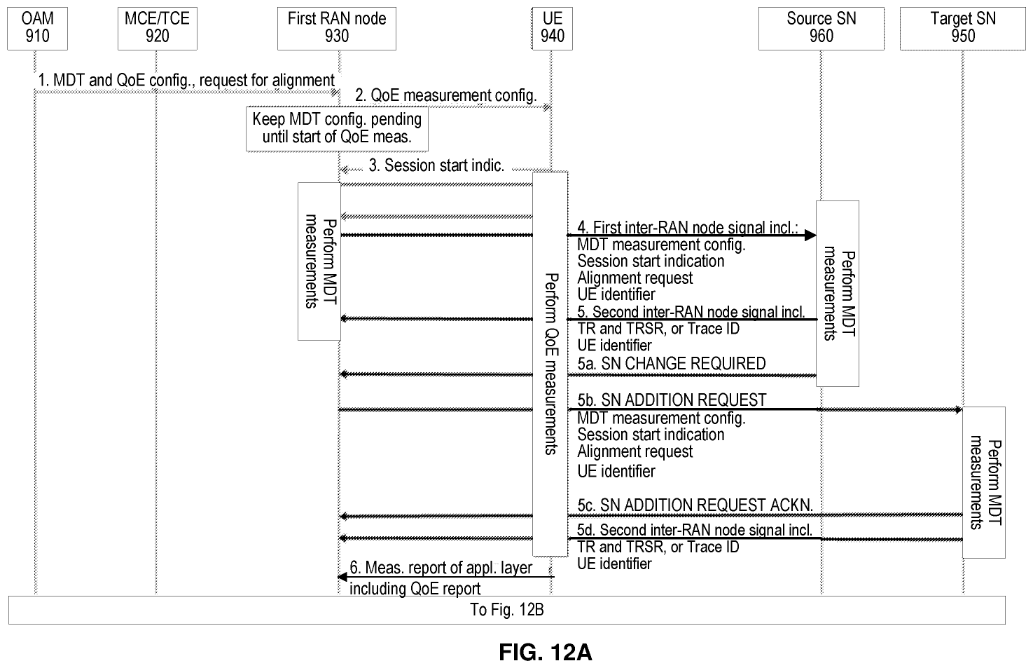

In addition, FIG. 14 shows an exemplary method (e.g., procedure) for a second RAN node configured to provide DC for a UE together with a first RAN node, according to various embodiments of the present disclosure. The exemplary method can be performed by a RAN node (e.g., gNB or unit or function thereof, such as CU-CP) such as described elsewhere herein.

The exemplary method can include the operations of block 1410, where the second RAN node can receive, from the first RAN node, a command to initiate MDT measurements that should be time aligned with QoE measurements performed by the UE. The exemplary method can also include the operations of block 1430, where the second RAN node can initiate time aligned MDT measurements in accordance with the command. The exemplary method can also include the operations of block 1450, where the second RAN node can send, to a measurement collection node or function (MCNF) associated with the RAN, an MDT report comprising results of the time aligned MDT measurements.

In some embodiments, the QoE measurements include RAN-visible QoE measurements. In some embodiments, the command is based on initiation of one of the following at the UE: an application session having characteristics related to the QoE measurements; or a QoE measurement session. In some embodiments, the command is received together with a second configuration for MDT measurements by the second RAN node and the time aligned MDT measurements are initiated according to the second configuration.

In some embodiments, one or more of the following information is received from the first RAN node together with the command:
at least a portion of a second configuration for second MDT measurements by the second RAN node;
one or more identifiers of first MDT measurements by the first RAN node;
a start time for the first MDT measurements;
one or more UE identifiers;
a first indication that a UE event associated with the QoE measurements has occurred; and
an indication or request for the second RAN node to provide information about second MDT measurements performed by second RAN node.
   Different variants of these embodiments are described below.

In some variants, the second configuration is associated with a first RAT, and one of the following applies:
the at least a portion of the second configuration is included with the command when the second RAN node uses the first RAT to serve the UE;
the at least a portion of the second configuration is included with the command when the second RAN node uses a second RAT to serve the UE; or
the at least a portion of the second configuration is included with the command in a form suitable for the second RAT.

In other variants, the at least a portion of the second configuration is included with the command when the second RAN node serves the UE with a RAT that supports a service type associated with the QoE measurements.

In other variants, one of the following information is also received from the first RAN node together with the command to initiate MDT measurements:
a command to add the second RAN node as the UE's SN for DC; or
a command to change the UE's SN from a third RAN node to the second RAN node.

In some of these embodiments, the exemplary method is performed by a CU-CP of the second RAN node and also includes the operations of block 1420, where the CU-CP can send the second configuration, or a portion thereof, to one or more units or functions of the second RAN node. The one or more units or functions of the second RAN node include one of more of the following: a CU-UP, and one or more DUs.

In other embodiments, an identifier of a second configuration for MDT measurements is received from the first RAN node together with the command. In such case, the command indicates that the second RAN node should initiate second MDT measurements according to the identified second configuration.

In some embodiments, the exemplary method can also include the operations of block 1440, where the second RAN node can send to the first RAN node one or more second identifiers of the time aligned MDT measurements initiated by the second RAN node responsive to the command. In some embodiments, each second identifier one of the following: a Trace Recording Session Reference (TRSR); a Trace Reference (TR) and a TRSR; or a Trace identifier (ID).

In some embodiments, the exemplary method can also include the operations of block 1460, where after sending the MDT report, the second RAN node can receive one of the following commands from the first RAN node: a command to release the second configuration; or a command to maintain the second configuration in an inactive state.

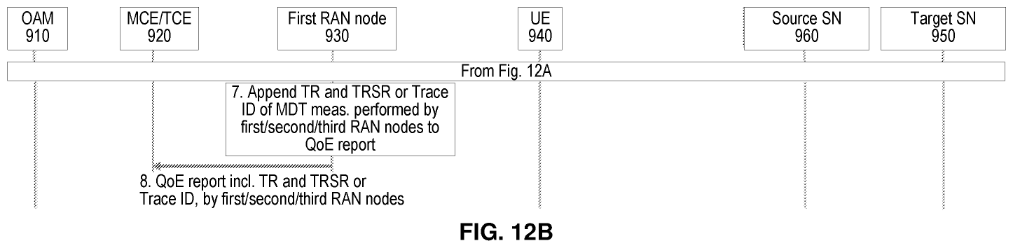

In addition, FIG. 15 shows an exemplary method (e.g., procedure) for a measurement collection node or function (MCNF) associated with a RAN, according to various embodiments of the present disclosure. The exemplary method can be performed by any appropriate MCNF (e.g., MCE, TCE, OAM) such as described elsewhere herein.

The exemplary method can include the operations of block 1510, where the MCNF can receive the following information from a first RAN node:
a QoE report comprising results of QoE measurements performed by a UE according to a first configuration;
one or first more identifiers of first MDT measurements performed by the first RAN node according to a second configuration; and
one or more second identifiers of second MDT measurements performed by a second RAN node according to the second configuration.
   The QoE measurements, the first MDT measurements, and the second MDT measurements are time aligned, as described above. The exemplary method can also include the operations of blocks 1520-1530, where the MCNF can collect the first MDT measurements and the second MDT measurements from the RAN and correlate the QoE measurements, the first MDT measurements, and the second MDT measurements based on the one or more first identifiers and the one or more second identifiers.

In some embodiments, the QoE measurements include RAN-visible QoE measurements. In some embodiments, collecting the first MDT measurements and the second MDT measurements in block 1520 includes the following operations labelled with corresponding sub-block numbers:
(1521) receiving, from the first RAN node, a first MDT report comprising the first MDT measurements and the one or more first identifiers; and
(1522) receiving, from the second RAN node, a second MDT report comprising the second MDT measurements and the one or more second identifiers.

In some embodiments, the second identifiers are one of the following: a Trace Recording Session Reference (TRSR), a Trace Reference (TR) and a TRSR, or a Trace identifier (ID).

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

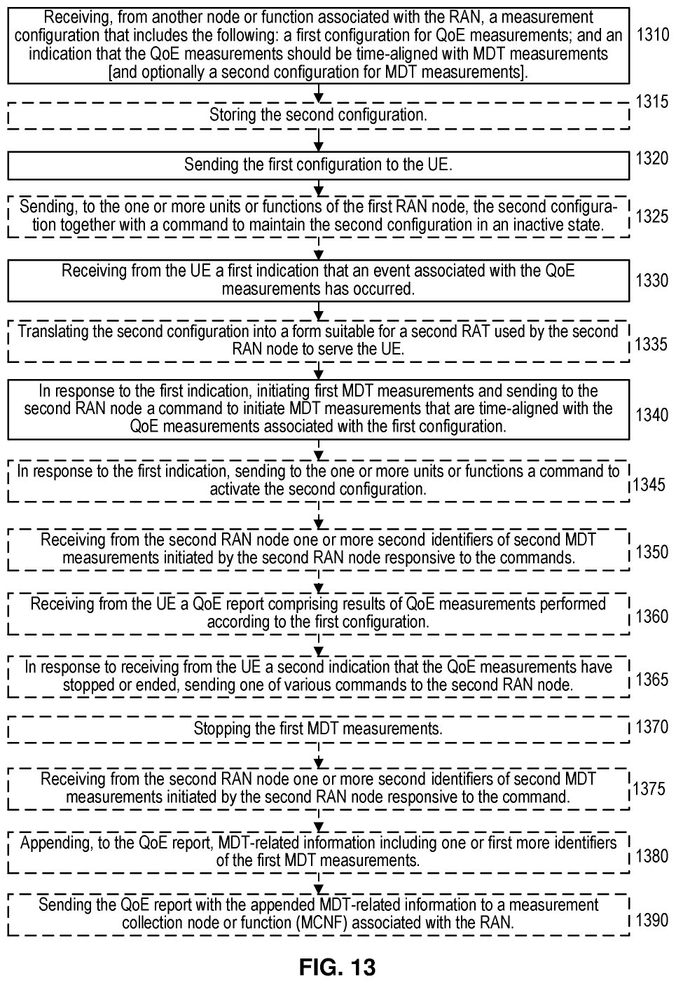

FIG. 16 shows an example of a communication system 1600 in accordance with some embodiments. In this example, communication system 1600 includes a telecommunication network 1602 that includes an access network 1604 (e.g., RAN) and a core network 1606, which includes one or more core network nodes 1608. Access network 1604 includes one or more access network nodes, such as network nodes 1610a-b (one or more of which may be generally referred to as network nodes 1610), or any other similar 3GPP access node or non-3GPP access point. Network nodes 1610 facilitate direct or indirect connection of UEs, such as by connecting UEs 1612a-d (one or more of which may be generally referred to as UEs 1612) to core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1600 may include any number of wired or wireless networks, network nodes, UEs, and/or any other components or systems that may facilitate or participate in the communication of data and/or signals whether via wired or wireless connections. Communication system 1600 may include and/or interface with any type of communication, telecommunication, data, cellular, radio network, and/or other similar type of system.

UEs 1612 may be any of a wide variety of communication devices, including wireless devices arranged, configured, and/or operable to communicate wirelessly with network nodes 1610 and other communication devices. Similarly, network nodes 1610 are arranged, capable, configured, and/or operable to communicate directly or indirectly with UEs 1612 and/or with other network nodes or equipment in telecommunication network 1602 to enable and/or provide network access, such as wireless network access, and/or to perform other functions, such as administration in telecommunication network 1602.

In the depicted example, core network 1606 connects network nodes 1610 to one or more hosts, such as host 1616. These connections may be direct or indirect via one or more intermediary networks or devices. In other examples, network nodes may be directly coupled to hosts. Core network 1606 includes one or more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1616 may be under the ownership or control of a service provider other than an operator or provider of access network 1604 and/or telecommunication network 1602, and may be operated by the service provider or on behalf of the service provider. Host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1602 is a cellular network that implements 3GPP standardized features. Accordingly, the telecommunications network 1602 may support network slicing to provide different logical networks to different devices that are connected to telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1612 are configured to transmit and/or receive information without direct human interaction. For instance, a UE may be designed to transmit information to access network 1604 on a predetermined schedule, when triggered by an internal or external event, or in response to requests from access network 1604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 1614 communicates with access network 1604 to facilitate indirect communication between one or more UEs (e.g., UE 1612c and/or 1612d) and network nodes (e.g., network node 1610b). In some examples, hub 1614 may be a controller, router, content source and analytics, or any of the other communication devices described herein regarding UEs. For example, hub 1614 may be a broadband router enabling access to core network 1606 for the UEs. As another example, hub 1614 may be a controller that sends commands or instructions to one or more actuators in the UEs. Commands or instructions may be received from the UEs, network nodes 1610, or by executable code, script, process, or other instructions in hub 1614. As another example, hub 1614 may be a data collector that acts as temporary storage for UE data and, in some embodiments, may perform analysis or other processing of the data. As another example, hub 1614 may be a content source. For example, for a UE that is a VR headset, display, loudspeaker or other media delivery device, hub 1614 may retrieve VR assets, video, audio, or other media or data related to sensory information via a network node, which hub 1614 then provides to the UE either directly, after performing local processing, and/or after adding additional local content. In still another example, hub 1614 acts as a proxy server or orchestrator for the UEs, in particular in if one or more of the UEs are low energy IoT devices.

Hub 1614 may have a constant/persistent or intermittent connection to network node 1610b. Hub 1614 may also allow for a different communication scheme and/or schedule between hub 1614 and UEs (e.g., UE 1612c and/or 1612d), and between hub 1614 and core network 1606. In other examples, hub 1614 is connected to core network 1606 and/or one or more UEs via a wired connection. Moreover, hub 1614 may be configured to connect to an M2M service provider over access network 1604 and/or to another UE over a direct connection. In some scenarios, UEs may establish a wireless connection with network nodes 1610 while still connected via hub 1614 via a wired or wireless connection. In some embodiments, hub 1614 may be a dedicated hub-that is, a hub whose primary function is to route communications to/from the UEs from/to network node 1610b. In other embodiments, hub 1614 may be a non-dedicated hub—that is, a device which is capable of operating to route communications between the UEs and network node 1610b, but which is additionally capable of operating as a communication start and/or end point for certain data channels.

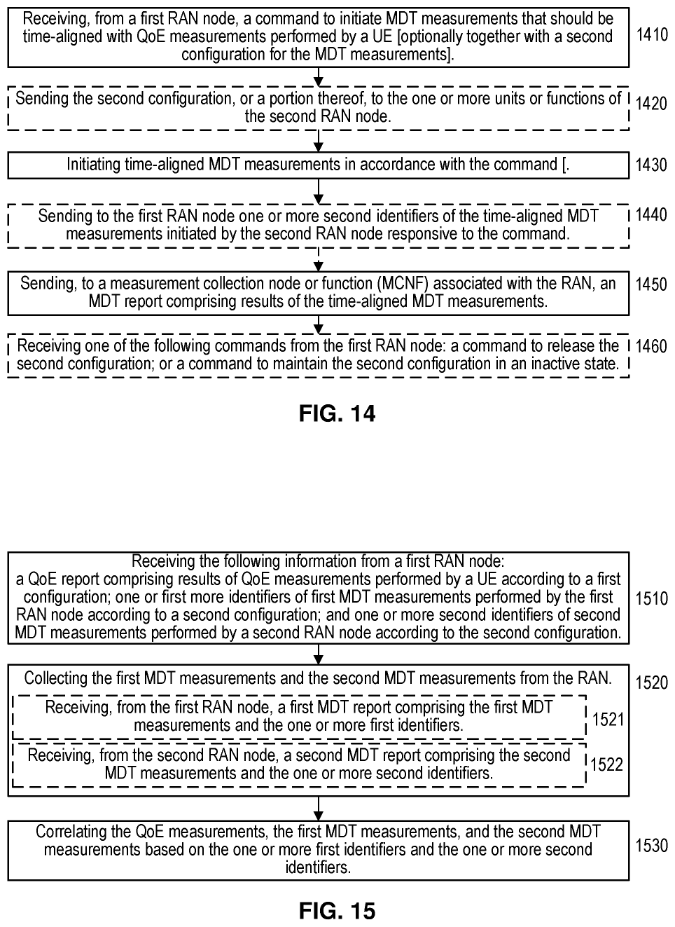

FIG. 17 shows a UE 1700 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1700 includes processing circuitry 1702 that is operatively coupled via bus 1704 to input/output interface 1706, power source 1708, memory 1710, communication interface 1712, and/or possible other components. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

Processing circuitry 1702 is configured to process instructions and data and may be configured to implement any sequential state machine operative to execute instructions stored as machine-readable computer programs in memory 1710. Processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1702 may include multiple central processing units (CPUs).

In the example, input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1708 is structured as a battery or battery pack. Other types of power sources, such as an external power source (e.g., an electricity outlet), photovoltaic device, or power cell, may be used. Power source 1708 may further include power circuitry for delivering power from power source 1708 itself, and/or an external power source, to the various parts of UE 1700 via input circuitry or an interface such as an electrical power cable. Delivering power may be, for example, for charging of power source 1708. Power circuitry may perform any formatting, converting, or other modification to the power from power source 1708 to make the power suitable for the respective components of UE 1700 to which power is supplied.

Memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1710 includes one or more application programs 1714, such as an operating system, web browser application, a widget, gadget engine, or other application, and corresponding data 1716. Memory 1710 may store, for use by UE 1700, any of a variety of various operating systems or combinations of operating systems.

Memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1710 may allow UE 1700 to access instructions, application programs and the like, stored on transitory or non-transitory memory media, to off-load data, or to upload data. An article of manufacture, such as one utilizing a communication system may be tangibly embodied as or in memory 1710, which may be or comprise a device-readable storage medium.

Processing circuitry 1702 may be configured to communicate with an access network or other network using communication interface 1712. Communication interface 1712 may comprise one or more communication subsystems and may include or be communicatively coupled to an antenna 1722. Communication interface 1712 may include one or more transceivers used to communicate, such as by communicating with one or more remote transceivers of another device capable of wireless communication (e.g., another UE or a network node in an access network). Each transceiver may include transmitter 1718 and/or receiver 1720 appropriate to provide network communications (e.g., optical, electrical, frequency allocations, and so forth). Moreover, transmitter 1718 and receiver 1720 may be coupled to one or more antennas (e.g., 1722) and may share circuit components, software, or firmware, or alternatively be implemented separately.

In the illustrated embodiment, communication functions of communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

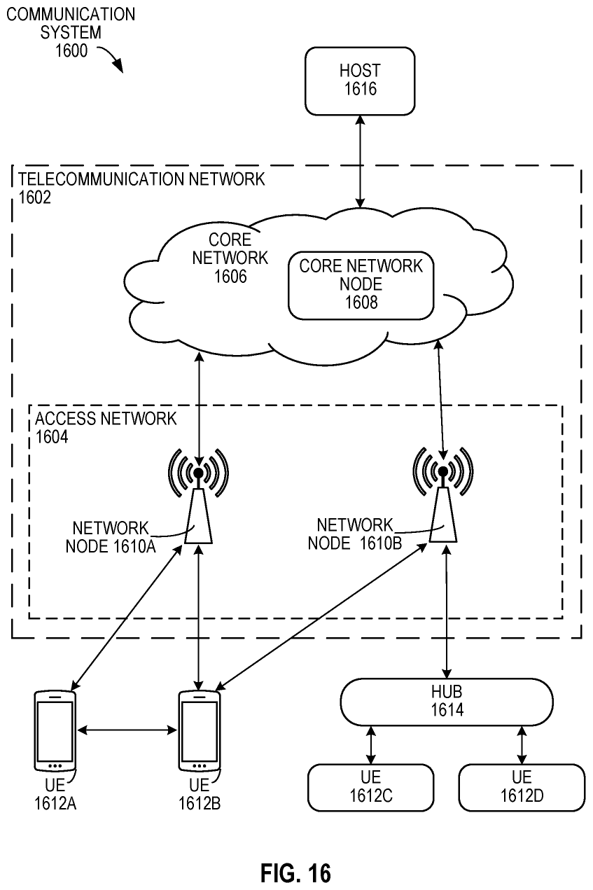

FIG. 18 shows a network node 1800 in accordance with some embodiments. Examples of network nodes include, but are not limited to, access points (e.g., radio access points) and base stations (e.g., radio base stations, Node Bs, eNBs, gNBs, etc.).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1800 includes processing circuitry 1802, memory 1804, communication interface 1806, and power source 1808. Network node 1800 may be composed of multiple physically separate components (e.g., a NodeB component and a RNC component, or a BTS component and a BSC component, etc.), which may each have their own respective components. In certain scenarios in which network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). Network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

Processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as memory 1804, to provide network node 1800 functionality.

In some embodiments, processing circuitry 1802 includes a system on a chip (SOC). In some embodiments, processing circuitry 1802 includes one or more of radio frequency (RF) transceiver circuitry 1812 and baseband processing circuitry 1814. In some embodiments, RF transceiver circuitry 1812 and baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

Memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1802. Memory 1804 may store any suitable instructions, data, or information, including a computer program, software, an application including one or more of logic, rules, code, tables, and/or other instructions (collectively denoted computer program 1804a, which may be in the form of a computer program product) capable of being executed by processing circuitry 1802 and utilized by network node 1800. Memory 1804 may be used to store any calculations made by processing circuitry 1802 and/or any data received via communication interface 1806. In some embodiments, processing circuitry 1802 and memory 1804 is integrated.

Communication interface 1806 is used in wired or wireless communication of signaling and/or data between a network node, access network, and/or UE. As illustrated, communication interface 1806 comprises port(s)/terminal(s) 1816 to send and receive data, for example to and from a network over a wired connection. Communication interface 1806 also includes radio front-end circuitry 1818 that may be coupled to, or in certain embodiments a part of, antenna 1810. Radio front-end circuitry 1818 comprises filters 1820 and amplifiers 1822. Radio front-end circuitry 1818 may be connected to an antenna 1810 and processing circuitry 1802. The radio front-end circuitry may be configured to condition signals communicated between antenna 1810 and processing circuitry 1802. Radio front-end circuitry 1818 may receive digital data that is to be sent out to other network nodes or UEs via a wireless connection. Radio front-end circuitry 1818 may convert the digital data into a radio signal having the appropriate channel and bandwidth parameters using a combination of filters 1820 and/or amplifiers 1822. The radio signal may then be transmitted via antenna 1810. Similarly, when receiving data, antenna 1810 may collect radio signals which are then converted into digital data by radio front-end circuitry 1818. The digital data may be passed to processing circuitry 1802. In other embodiments, the communication interface may comprise different components and/or different combinations of components.

In certain alternative embodiments, network node 1800 does not include separate radio front-end circuitry 1818, instead, processing circuitry 1802 includes radio front-end circuitry and is connected to antenna 1810. Similarly, in some embodiments, all or some of RF transceiver circuitry 1812 is part of communication interface 1806. In still other embodiments, communication interface 1806 includes one or more ports or terminals 1816, radio front-end circuitry 1818, and RF transceiver circuitry 1812, as part of a radio unit (not shown), and communication interface 1806 communicates with baseband processing circuitry 1814, which is part of a digital unit (not shown).

Antenna 1810 may include one or more antennas, or antenna arrays, configured to send and/or receive wireless signals. Antenna 1810 may be coupled to radio front-end circuitry 1818 and may be any type of antenna capable of transmitting and receiving data and/or signals wirelessly. In certain embodiments, antenna 1810 is separate from network node 1800 and connectable to network node 1800 through an interface or port.

Antenna 1810, communication interface 1806, and/or processing circuitry 1802 may be configured to perform any receiving operations and/or certain obtaining operations described herein as being performed by the network node. Any information, data and/or signals may be received from a UE, another network node and/or any other network equipment. Similarly, antenna 1810, communication interface 1806, and/or processing circuitry 1802 may be configured to perform any transmitting operations described herein as being performed by the network node. Any information, data and/or signals may be transmitted to a UE, another network node and/or any other network equipment.

Power source 1808 provides power to the various components of network node 1800 in a form suitable for the respective components (e.g., at a voltage and current level needed for each respective component). Power source 1808 may further comprise, or be coupled to, power management circuitry to supply the components of network node 1800 with power for performing the functionality described herein. For example, network node 1800 may be connectable to an external power source (e.g., the power grid, an electricity outlet) via an input circuitry or interface such as an electrical cable, whereby the external power source supplies power to power circuitry of power source 1808. As a further example, power source 1808 may comprise a source of power in the form of a battery or battery pack which is connected to, or integrated in, power circuitry. The battery may provide backup power should the external power source fail.

Embodiments of network node 1800 may include additional components beyond those shown in FIG. 18 for providing certain aspects of the network node's functionality, including any of the functionality described herein and/or any functionality necessary to support the subject matter described herein. For example, network node 1800 may include user interface equipment to allow input of information into network node 1800 and to allow output of information from network node 1800. This may allow a user to perform diagnostic, maintenance, repair, and other administrative functions for network node 1800.

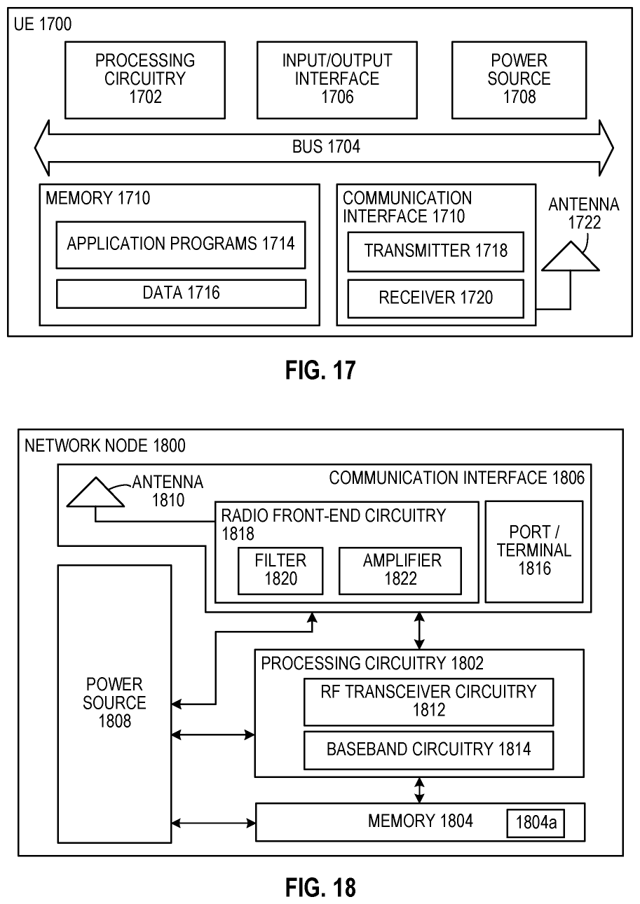

FIG. 19 is a block diagram of a host 1900, which may be an embodiment of host 1616 of FIG. 16, in accordance with various aspects described herein. As used herein, host 1900 may be or comprise various combinations hardware and/or software, including a standalone server, a blade server, a cloud-implemented server, a distributed server, a virtual machine, container, or processing resources in a server farm. Host 1900 may provide one or more services to one or more UEs.

Host 1900 includes processing circuitry 1902 that is operatively coupled via bus 1904 to input/output interface 1906, network interface 1908, power source 1910, and memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

Memory 1912 may include one or more computer programs including one or more host application programs 1914 and data 1916, which may include user data, e.g., data generated by a UE for host 1900 or data generated by host 1900 for a UE. Embodiments of host 1900 may utilize only a subset or all of the components shown. Host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1914 may also provide for user authentication and licensing checks and may periodically report health, routes, and content availability to a central node, such as a device in or on the edge of a core network. Accordingly, host 1900 may select and/or indicate a different host for over-the-top services for a UE. Host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

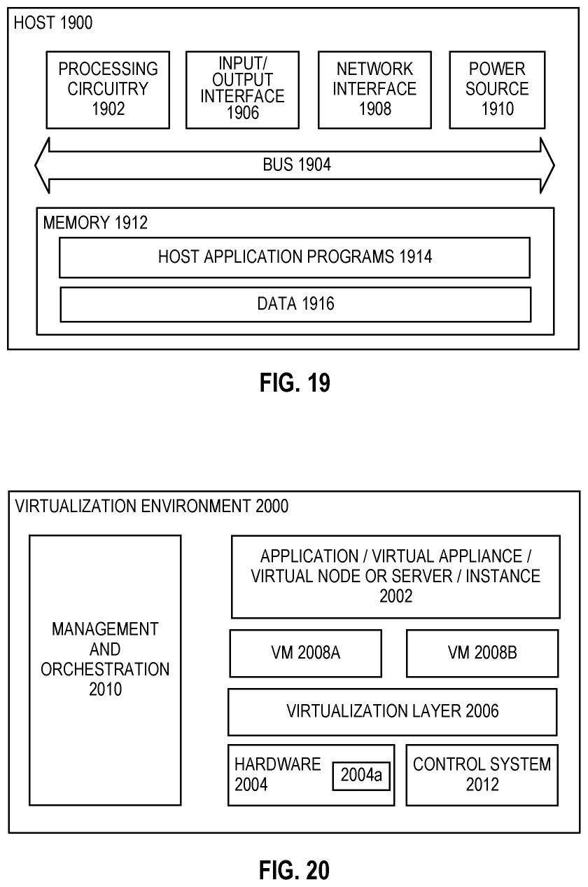

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment 1900 to implement some of the features, functions, and/or benefits of some of the embodiments disclosed herein.

Hardware 2004 includes processing circuitry, memory that stores software and/or instructions (collectively denoted computer program 2004a, which may be in the form of a computer program product) executable by hardware processing circuitry, and/or other hardware circuitry as described herein, such as a communication interface, input/output interface, and so forth. Software may be executed by the processing circuitry to instantiate one or more virtualization layers 2006 (also referred to as hypervisors or virtual machine monitors (VMMs)), provide VMs 2008a-b (one or more of which may be generally referred to as VMs 2008), and/or perform any of the functions, features and/or benefits described in relation with some embodiments described herein. Virtualization layer 2006 may present a virtual operating platform that appears like networking hardware to VMs 2008.

VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 2008 may be a software implementation of a physical machine that runs programs as if they were executing on a physical, non-virtualized machine. Each VM 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

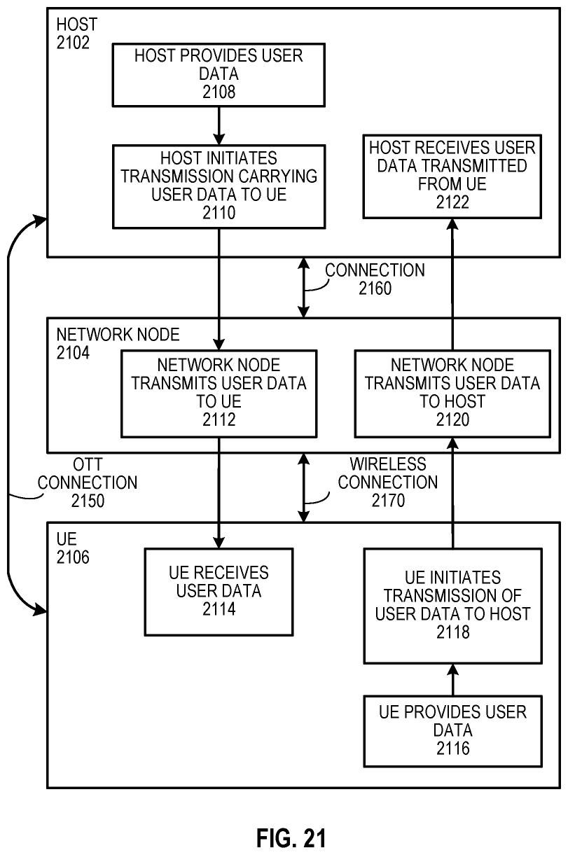

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. Host 2102 also includes software, which is stored in or accessible by host 2102 and executable by the processing circuitry. The software includes a host application that may be operable to provide a service to a remote user, such as UE 2106 connecting via an over-the-top (OTT) connection 2150 extending between UE 2106 and host 2102. In providing the service to the remote user, a host application may provide user data which is transmitted using OTT connection 2150.

Network node 2104 includes hardware enabling it to communicate with host 2102 and UE 2106. Connection 2160 may be direct or pass through a core network (like core network 1606 of FIG. 16) and/or one or more other intermediate networks, such as one or more public, private, or hosted networks. For example, an intermediate network may be a backbone network or the Internet.

UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of host 2102. In host 2102, an executing host application may communicate with the executing client application via OTT connection 2150 terminating at UE 2106 and host 2102. In providing the service to the user, the UE's client application may receive request data from the host's host application and provide user data in response to the request data. OTT connection 2150 may transfer both the request data and the user data. The UE's client application may interact with the user to generate the user data that it provides to the host application through OTT connection 2150.

OTT connection 2150 may extend via a connection 2160 between host 2102 and network node 2104 and via wireless connection 2170 between network node 2104 and UE 2106 to provide the connection between host 2102 and UE 2106. Connection 2160 and wireless connection 2170, over which OTT connection 2150 may be provided, have been drawn abstractly to illustrate the communication between host 2102 and UE 2106 via network node 2104, without explicit reference to any intermediary devices and the precise routing of messages via these devices.

As an example of transmitting data via OTT connection 2150, in step 2108, host 2102 provides user data, which may be performed by executing a host application. In some embodiments, the user data is associated with a particular human user interacting with UE 2106. In other embodiments, the user data is associated with a UE 2106 that shares data with host 2102 without explicit human interaction. In step 2110, host 2102 initiates a transmission carrying the user data towards UE 2106. Host 2102 may initiate the transmission responsive to a request transmitted by UE 2106. The request may be caused by human interaction with UE 2106 or by operation of the client application executing on UE 2106. The transmission may pass via network node 2104, in accordance with the teachings of the embodiments described throughout this disclosure. Accordingly, in step 2112, network node 2104 transmits to UE 2106 the user data that was carried in the transmission that host 2102 initiated, in accordance with the teachings of the embodiments described throughout this disclosure. In step 2114, UE 2106 receives the user data carried in the transmission, which may be performed by a client application executed on UE 2106 associated with the host application executed by host 2102.

In some examples, UE 2106 executes a client application which provides user data to host 2102. The user data may be provided in reaction or response to the data received from host 2102. Accordingly, in step 2116, UE 2106 may provide user data, which may be performed by executing the client application. In providing the user data, the client application may further consider user input received from the user via an input/output interface of UE 2106. Regardless of the specific manner in which the user data was provided, UE 2106 initiates, in step 2118, transmission of the user data towards host 2102 via network node 2104. In step 2120, in accordance with the teachings of the embodiments described throughout this disclosure, network node 2104 receives user data from UE 2106 and initiates transmission of the received user data towards host 2102. In step 2122, host 2102 receives the user data carried in the transmission initiated by UE 2106.

One or more of the various embodiments improve the performance of OTT services provided to UE 2106 using OTT connection 2150, in which wireless connection 2170 forms the last segment. More precisely, By enabling RAN nodes arranged in DC with a single UE to perform MDT measurements in time aligned way with QoE measurements (including legacy and RVQoE measurements), these and other embodiments described herein can facilitate easy correlation of these measurements by a collection entity. This can lead to detection, interpretation, and/or understanding of possible application-related issues and/or possible radio- and network-related issues. Availability of time aligned measurements in this manner can lead to improved network performance. OTT services will experience this improved network performance, which increases the value of such OTT services to end users and service providers.

In an example scenario, factory status information may be collected and analyzed by host 2102. As another example, host 2102 may process audio and video data which may have been retrieved from a UE for use in creating maps. As another example, host 2102 may collect and analyze real-time data to assist in controlling vehicle congestion (e.g., controlling traffic lights). As another example, host 2102 may store surveillance video uploaded by a UE. As another example, host 2102 may store or control access to media content such as video, audio, VR or AR which it can broadcast, multicast or unicast to UEs. As other examples, host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 2150 between host 2102 and UE 2106, in response to variations in the measurement results. The measurement procedure and/or the network functionality for reconfiguring the OTT connection may be implemented in software and hardware of host 2102 and/or UE 2106. In some embodiments, sensors (not shown) may be deployed in or in association with other devices through which OTT connection 2150 passes; the sensors may participate in the measurement procedure by supplying values of the monitored quantities exemplified above, or supplying values of other physical quantities from which software may compute or estimate the monitored quantities. The reconfiguring of OTT connection 2150 may include message format, retransmission settings, preferred routing etc.; the reconfiguring need not directly alter the operation of network node 2104. Such procedures and functionalities may be known and practiced in the art. In certain embodiments, measurements may involve proprietary UE signaling that facilitates measurements of throughput, propagation times, latency and the like, by host 2102. The measurements may be implemented in that software causes messages to be transmitted, in particular empty or ‘dummy’ messages, using OTT connection 2150 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method performed by a first radio access network (RAN) node configured to provide dual connectivity (DC) for a user equipment (UE) together with a second RAN node, the method comprising:
receiving, from another node or function associated with the RAN, a measurement configuration that includes the following:
   a first configuration for quality-of-experience (QoE) measurements, and
   an indication that the QoE measurements should be time aligned with minimization of drive testing (MDT) measurements;
sending the first configuration to the UE;
receiving from the UE a first indication that an event associated with the QoE measurements has occurred; and
in response to the first indication, initiating first MDT measurements and sending to the second RAN node a command to initiate MDT measurements that are time aligned with the QoE measurements associated with the first configuration.

A2. The method of embodiment A1, wherein the event is one of the following:
initiation of a UE application session having characteristics related to the first configuration; or
initiation of a UE QoE measurement session associated with the first configuration.

A3. The method of any of embodiments A1-A2, wherein the other node or function associated with the RAN is one of the following: an operations administration maintenance (OAM) node coupled to the RAN; or a node or function of a core network (CN) coupled to the RAN.

A4. The method of any of embodiments A1-A3, wherein:
the measurement configuration also includes a second configuration for MDT measurements; and
the indication indicates that the QoE measurements should be time aligned with the MDT measurements associated with the second configuration,

A4a. The method of embodiment A4, wherein:
the method further comprises storing the second configuration upon receipt; and
the first MDT measurements are initiated according to the stored second configuration.

A4b. The method of any of embodiments A4-A4a, wherein at least a portion of the second configuration is sent to the UE together with the first configuration.

A4c. The method of any of embodiments A4-A4b, wherein one of the first configuration and the second configuration includes an indication of the event associated with the QoE measurements.

A4d. The method of any of embodiments A4-A4c, wherein one or more of the following information is sent to the second RAN node together with the command:
at least a portion of the second configuration;
one or more identifiers of the first MDT measurements;
a start time for the first MDT measurements;
one or more UE identifiers;
the first indication received from the UE, or a representation thereof; and
an indication or request for the second RAN node to provide information about second MDT measurements performed by second RAN node.

A4e. The method of embodiment A4d, wherein the second configuration is associated with a first radio access technology (RAT), and one of the following applies:
the at least a portion of the second configuration is included with the command when the second RAN node uses the first RAT to serve the UE;
the at least a portion of the second configuration is included with the command when the second RAN node uses a second RAT to serve the UE; or
the method further comprises translating the second configuration into a form suitable for a second RAT used by the second RAN node to serve the UE, wherein the form suitable for the second RAT is included with the command.

A4f. The method of embodiment A4d, wherein the first configuration includes a service type associated with the QoE measurements, and the at least a portion of the second configuration is included with the command when the second RAN node serves the UE with a radio access technology (RAT) that supports the service type.

A4g. The method of embodiment A4d, wherein the command to initiate MDT measurements and the information is sent to the second RAN node together with one of the following:
a command to add the second RAN node as the UE's secondary node (SN) for DC; or
a command to change the UE's SN from a third RAN node to the second RAN node.

A4h. The method of any of embodiments A1-A3, wherein:
the second configuration includes two second configurations, one associated with a first radio access technology (RAT) and another associated with a second RAT;
the MDT measurements are initiated according the second configuration associated with the second RAT; and
at least a portion of the second configuration associated with the second RAT is sent to the second RAN node together with the command.

A4i. The method of any of embodiments A4-A4h, further comprising:
sending the second configuration to the one or more units or functions of the first RAN node, together with a command to maintain the second configuration in an inactive state; and
in response to the first indication, sending the one or more units or functions a command to activate the second configuration.

A4j. The method of embodiment A4i, wherein the method is performed by a centralized unit control plane (CU-CP) of the first RAN node, and the one or more units or functions include one of more of the following: a centralized unit user plane (CU-UP), and one or more distributed units (DU).

A5. The method of any of claims A1-A3, wherein:
an identifier of a second configuration for MDT measurements is sent to the second RAN node together with the command; and
the command indicates that the second RAN node should initiate second MDT measurements according to the identified second configuration.

A6. The method of any of embodiments A1-A5:
receiving from the UE a QoE report comprising results of QoE measurements performed according to the first configuration;
stopping the first MDT measurements;
appending, to the QoE report, MDT-related information including one or first more identifiers of the first MDT measurements; and
sending the QoE report with the appended MDT-related information to a measurement collection node or function (MCNF) associated with the RAN.

A7. The method of embodiment A6, wherein:
the method further comprises receiving from the second RAN node one or more second identifiers of second MDT measurements initiated by the second RAN node responsive to the commands; and
the MDT-related information appended to the QoE report also includes the one or more second identifiers.

A8. The method of embodiment A7, where the appended second identifiers are one of the following: a Trace Recording Session Reference (TRSR), a Trace Reference (TR) and a TRSR, or a Trace identifier (ID).

A9. The method of any of embodiments A6-A8, further comprising, in response to receiving the QoE report or another indication that the QoE measurements have stopped or ended, sending one of the following commands to the second RAN node:
a command to release the second configuration; or
a command to maintain the second configuration in an inactive state.

B1. A method performed by a second radio access network (RAN) node configured to provide dual connectivity (DC) for a user equipment (UE) together with a first RAN node, the method comprising:
receiving, from the first RAN node, a command to initiate minimization of drive testing (MDT) measurements that should be time aligned with quality-of-experience (QoE) measurements performed by a user equipment (UE);
initiating time aligned MDT measurements in accordance with the command; and
sending, to a measurement collection node or function (MCNF) associated with the RAN, an MDT report comprising results of the time aligned MDT measurements.

B2. The method of embodiment B1, wherein the command is based on initiation of one of the following at the UE:
an application session having characteristics related to the QoE measurements; or
a QoE measurement session.

B3. The method of any of embodiments B1-B2, wherein:
the command is received together with a second configuration for MDT measurements by the second RAN node; and
the time aligned MDT measurements are initiated according to the second configuration.

B4. The method of any of embodiments B1-B3, wherein one or more of the following information is received from the first RAN node together with the command:
at least a portion of a second configuration for second MDT measurements by the second RAN node;
one or more identifiers of first MDT measurements by the first RAN node;
a start time for the first MDT measurements;
one or more UE identifiers;
a first indication that a UE event associated with the QoE measurements has occurred; and
an indication or request for the second RAN node to provide information about second MDT measurements performed by second RAN node;

B4a. The method of embodiment B4, wherein the second configuration is associated with a first radio access technology (RAT), and one of the following applies:
the at least a portion of the second configuration is included with the command when the second RAN node uses the first RAT to serve the UE;
the at least a portion of the second configuration is included with the command when the second RAN node uses a second RAT to serve the UE; and
the at least a portion of the second configuration is included with the command in a form suitable for the second RAT.

B4b. The method of embodiment B4, wherein the at least a portion of the second configuration is included with the command when the second RAN node serves the UE with a radio access technology (RAT) that supports a service type associated with the QoE measurements.

B4c. The method of embodiment B4, wherein the command to initiate MDT measurements and the information is received from the first RAN node together with one of the following:
a command to add the second RAN node as the UE's secondary node (SN) for DC;
a command to change the UE's SN from a third RAN node to the second RAN node.

B5. The method of any of embodiments B3-B4c, further comprising sending the second configuration, or a portion thereof, to the one or more units or functions of the second RAN node.

B5a. The method of embodiment B5, wherein the method is performed by a centralized unit control plane (CU-CP) of the second RAN node, and the one or more units or functions include one of more of the following: a centralized unit user plane (CU-UP), and one or more distributed units (DU).

B6. The method of any of claims B1-B2, wherein:
an identifier of a second configuration for MDT measurements is received from the first RAN node together with the command; and
the command indicates that the second RAN node should initiate second MDT measurements according to the identified second configuration.

B7. The method of any of embodiments B1-B6, further comprising sending to the first RAN node one or more second identifiers of the time aligned MDT measurements initiated by the second RAN node responsive to the command.

B8. The method of embodiment B7, where the second identifiers are one of the following: a Trace Recording Session Reference (TRSR), a Trace Reference (TR) and a TRSR, or a Trace identifier (ID).

B9. The method of any of embodiments B1-B8, further comprising, after sending the MDT report, receiving one of the following commands from the first RAN node:
a command to release the second configuration; or
a command to maintain the second configuration in an inactive state.

C1. A method performed by a measurement collection node or function (MCNF) associated with a radio access network (RAN), the method comprising:
receiving the following information from a first RAN node:
   a quality-of-experience (QoE) report comprising results of QoE measurements performed by a user equipment (UE) according to a first configuration;
   one or first more identifiers of first minimization of drive testing (MDT) measurements performed by the first RAN node according to a second configuration; and
   one or more second identifiers of second MDT measurements performed by a second RAN node according to the second configuration,
   wherein the QoE measurements, the first MDT measurements, and the second MDT measurements are time aligned; and
collecting the first MDT measurements and the second MDT measurements from the RAN; and
correlating the QoE measurements, the first MDT measurements, and the second MDT measurements based on the one or more first identifiers and the one or more second identifiers.

C2. The method of embodiment C1, wherein collecting the first MDT measurements and the second MDT measurements comprises:
receiving, from the first RAN node, a first MDT report comprising the first MDT measurements and the one or more first identifiers; and
receiving, from the second RAN node, a second MDT report comprising the second MDT measurements and the one or more second identifiers.

C3. The method of any of embodiments C1-C2, where the second identifiers are one of the following: a Trace Recording Session Reference (TRSR), a Trace Reference (TR) and a TRSR, or a Trace identifier (ID).

D1. A first radio access network (RAN) node configured to provide dual connectivity (DC) for a user equipment (UE) together with a second RAN node, the first RAN node comprising:
communication interface circuitry configured to communicate with a second RAN node and with UEs; and
processing circuitry operatively coupled to the communication interface circuitry, whereby the processing circuitry and the communication interface circuitry are configured to perform operations corresponding to any of the methods of embodiments A1-A9.

D2. A first radio access network (RAN) node configured to provide dual connectivity (DC) for a user equipment (UE) together with a second RAN node, the first RAN node being configured to perform operations corresponding to any of the methods of embodiments A1-A9.

D3. A non-transitory, computer-readable medium storing computer-executable instructions that, when executed by processing circuitry of first radio access network (RAN) node configured to provide dual connectivity (DC) for a user equipment (UE) together with a second RAN node, configure the first RAN node to perform operations corresponding to any of the methods of embodiments A1-A9.

D4. A computer program product comprising computer-executable instructions that, when executed by processing circuitry of first radio access network (RAN) node configured to provide dual connectivity (DC) for a user equipment (UE) together with a second RAN node, configure the first RAN node to perform operations corresponding to any of the methods of embodiments A1-A9.

E1. A second radio access network (RAN) node configured to provide dual connectivity (DC) for a user equipment (UE) together with a first RAN node, the second RAN node comprising:
communication interface circuitry configured to communicate with a first RAN node and with UEs; and
processing circuitry operatively coupled to the communication interface circuitry, whereby the processing circuitry and the communication interface circuitry are configured to perform operations corresponding to any of the methods of embodiments B1-B9.

E2. A second radio access network (RAN) node configured to provide dual connectivity (DC) for a user equipment (UE) together with a first RAN node, the second RAN node being configured to perform operations corresponding to any of the methods of embodiments B1-B9.

E3. A non-transitory, computer-readable medium storing computer-executable instructions that, when executed by processing circuitry of second radio access network (RAN) node configured to provide dual connectivity (DC) for a user equipment (UE) together with a first RAN node, configure the second RAN node to perform operations corresponding to any of the methods of embodiments B1-B9.

E4. A computer program product comprising computer-executable instructions that, when executed by processing circuitry of second radio access network (RAN) node configured to provide dual connectivity (DC) for a user equipment (UE) together with a first RAN node, configure the second RAN node to perform operations corresponding to any of the methods of embodiments B1-B9.

F1. A measurement collection node or function (MCNF) associated with a radio access network (RAN), the MCNF comprising:
communication interface circuitry configured to communicate with at least a first RAN node and a second RAN node; and
processing circuitry operatively coupled to the communication interface circuitry, whereby the processing circuitry and the communication interface circuitry are configured to perform operations corresponding to any of the methods of embodiments C1-C3.

F2. A measurement collection node or function (MCNF) associated with a radio access network (RAN), the MCNF being configured to perform operations corresponding to any of the methods of embodiments C1-C3.

F3 A non-transitory, computer-readable medium storing computer-executable instructions that, when executed by processing circuitry of a measurement collection node or function (MCNF) associated with a radio access network (RAN), configure the MCNF to perform operations corresponding to any of the methods of embodiments C1-C3.

F4. A computer program product comprising computer-executable instructions that, when executed by processing circuitry of a measurement collection node or function (MCNF) associated with a radio access network (RAN), configure the MCNF to perform operations corresponding to any of the methods of embodiments C1-C3.

1.-52. (canceled)

53. A method performed by a first radio access network (RAN) node configured to provide dual connectivity (DC) for a user equipment (UE) together with a second RAN node, the method comprising:
receiving, from an operations administration maintenance (OAM) node or from a node or function of a core network (CN), a measurement configuration that includes the following:
a first configuration for quality-of-experience (QoE) measurements, including RAN-visible QoE measurements, and
an indication that the QoE measurements should be time-aligned with minimization of drive testing (MDT) measurements;
sending the first configuration to the UE;
receiving from the UE a first indication that an event associated with the QoE measurements has occurred; and
in response to the first indication, initiating first MDT measurements and sending to the second RAN node a command to initiate MDT measurements that are time-aligned with the QoE measurements associated with the first configuration.

54. The method of claim 53, wherein the first indication is a session start indication for one of the following:
a UE application session having characteristics related to the first configuration; or
a UE QoE measurement session associated with the first configuration.

55. The method of claim 53, wherein:
the measurement configuration also includes a second configuration for MDT measurements; and
the indication also indicates that the QoE measurements should be time-aligned with the MDT measurements associated with the second configuration,

56. The method of claim 55, wherein one or more of the following applies:
at least a portion of the second configuration is sent to the UE together with the first configuration; and
one of the first configuration and the second configuration includes an indication of the event associated with the QoE measurements.

57. The method of claim 55, wherein one or more of the following information is sent to the second RAN node together with the command:
at least a portion of the second configuration, when the second RAN node serves the UE with a radio access technology (RAT) that supports a service type associated with the QoE measurements;
one or more identifiers of the first MDT measurements;
a start time for the first MDT measurements;
one or more UE identifiers;
the first indication received from the UE, or a representation thereof; and
an indication or request for the second RAN node to provide information about second MDT measurements performed by second RAN node.

58. The method of claim 57, wherein one of the following is also sent to the second RAN node together with the command to initiate MDT measurements:
a command to add the second RAN node as the UE's secondary node, SN, for DC; or
a command to change the UE's SN from a third RAN node to the second RAN node.

59. The method of claim 55, wherein the method is performed by a centralized unit control plane (CU-CP) of the first RAN node and further comprises:
sending, to one or more other units or functions of the first RAN node, the second configuration together with a command to maintain the second configuration in an inactive state; and
in response to the first indication, sending to the one or more units or functions of the first RAN node a command to activate the second configuration,
wherein the one or more other units or functions include one of more of the following: a centralized unit user plane, CU-UP; and one or more distributed units, DUs.

60. The method of claim 53, wherein:
an identifier of a second configuration for MDT measurements is sent to the second RAN node together with the command; and
the command indicates that the second RAN node should initiate second MDT measurements according to the identified second configuration.

61. The method of claim 53, further comprising:
receiving from the UE a QoE report comprising results of QoE measurements performed according to the first configuration;
appending, to the QoE report, MDT-related information including one or first more identifiers of the first MDT measurements; and
sending the QoE report with the appended MDT-related information to a measurement collection node or function (MCNF) associated with the RAN.

62. The method of claim 61, wherein:
the method further comprises receiving from the second RAN node one or more second identifiers of second MDT measurements initiated by the second RAN node responsive to the commands;
the MDT-related information appended to the QoE report also includes the one or more second identifiers; and
each second identifier is one of the following: a Trace Recording Session Reference (TRSR), a Trace Reference (TR) and a TRSR, or a Trace identifier.

63. A method performed by a second radio access network (RAN) node configured to provide dual connectivity (DC) for a user equipment (UE) together with a first RAN node, the method comprising:
receiving, from the first RAN node, a command to initiate minimization of drive testing (MDT) measurements that should be time-aligned with quality-of-experience (QoE) measurements performed by the UE, wherein the QoE measurements include RAN-visible QoE measurements;
initiating time-aligned MDT measurements in accordance with the command; and
sending, to a measurement collection node or function (MCNF) associated with the RAN, an MDT report comprising results of the time-aligned MDT measurements.

64. The method of claim 63, wherein the command is based on initiation of one of the following at the UE:
an application session having characteristics related to the QoE measurements; or
a QoE measurement session.

65. The method of claim 63, wherein:
the command is received together with a second configuration for MDT measurements by the second RAN node; and
the time-aligned MDT measurements are initiated according to the second configuration.

66. The method of claim 63, wherein one or more of the following information is received from the first RAN node together with the command to initiate MDT measurements:
at least a portion of a second configuration for second MDT measurements by the second RAN node, when the second RAN node serves the UE with a radio access technology (RAT) that supports a service type associated with the QoE measurements;
one or more identifiers of first MDT measurements by the first RAN node;
a start time for the first MDT measurements;
one or more UE identifiers;
a first indication that a UE event associated with the QoE measurements has occurred; and
an indication or request for the second RAN node to provide information about second MDT measurements performed by second RAN node;

67. The method of claim 66, wherein one of the following information is also received from the first RAN node together with the command to initiate MDT measurements:
a command to add the second RAN node as the UE's secondary node, SN, for DC; or
a command to change the UE's SN from a third RAN node to the second RAN node.

68. The method of claim 65, wherein:
the method is performed by a centralized unit control plane, CU-CP, of the second RAN node and further comprises sending the second configuration, or a portion thereof, to one or more units or functions of the second RAN node; and
the one or more units or functions include one of more of the following: a centralized unit user plane, CU-UP; and one or more distributed units, DUs.

69. The method of claim 63, wherein:
an identifier of a second configuration for MDT measurements is received from the first RAN node together with the command; and
the command indicates that the second RAN node should initiate second MDT measurements according to the identified second configuration.

70. The method of claim 63, further comprising sending to the first RAN node one or more second identifiers of the time-aligned MDT measurements initiated by the second RAN node responsive to the command, wherein each second identifier is one of the following: a Trace Recording Session Reference (TRSR), a Trace Reference (TR) and a TRSR, or a Trace identifier.

71. A first radio access network (RAN) node configured to provide dual connectivity (DC) for a user equipment (UE) together with a second RAN node, the first RAN node comprising:
communication interface circuitry configured to communicate with at least the second RAN node and the UE; and
processing circuitry operatively coupled to the communication interface circuitry, wherein the processing circuitry and the communication interface circuitry are configured to:
receive, from an operations administration maintenance (OAM) node or from a node or function of a core network (CN), a measurement configuration that includes the following:
a first configuration for quality-of-experience (QoE) measurements, including RAN-visible QoE measurements, and
an indication that the QoE measurements should be time-aligned with minimization of drive testing (MDT) measurements;
send the first configuration to the UE;
receive from the UE a first indication that an event associated with the QoE measurements has occurred; and
in response to the first indication, initiate first MDT measurements and send to the second RAN node a command to initiate MDT measurements that are time-aligned with the QoE measurements associated with the first configuration.

72. A second radio access network (RAN) node configured to provide dual connectivity (DC) for a user equipment (UE) together with a first RAN node, the second RAN node comprising:
communication interface circuitry configured to communicate with the first RAN node, with the UE, and with a measurement collection node or function (MCNF) associated with the RAN; and
processing circuitry operatively coupled to the communication interface circuitry, wherein the processing circuitry and the communication interface circuitry are configured to:
receive, from the first RAN node, a command to initiate minimization of drive testing (MDT) measurements that should be time-aligned with quality-of-experience (QoE) measurements performed by the UE, wherein the QoE measurements include RAN-visible QoE measurements;
initiate time-aligned MDT measurements in accordance with the command; and
send, to the MCNF, an MDT report comprising results of the time-aligned MDT measurements.
